(19) United States
(12) Patent Application Publication
(10) Pub. No.: US 2026/0307676 A1
(43) Pub. Date: Oct. 8, 2026

(54) ITERATIVE PROJECTION AND EVALUATION OF SCENE STATES USING END TO END NEURAL NETWORKS FOR AUTONOMOUS AND SEMI-AUTONOMOUS SYSTEMS AND APPLICATIONS

(71) Applicant: NVIDIA CORPORATION, Santa Clara, CA (US)

(72) Inventor: Urs Andrew Muller, Keyport, NJ (US)

(21) Appl. No.: 19/171,149

(22) Filed: Apr. 4, 2025

(51) Int. Cl. B60W 60/00; G06V 10/82

(52) U.S. Cl. CPC B60W 60/0011; B60W 60/00186; G06V 10/82

(57) ABSTRACT

In various examples, a modular (e.g., control, drive, software, software/hardware) stack may evaluate candidate trajectory(ies) by predicting the subsequent scene or world state that would result from using the candidate trajectory(ies), and quantifying a measure of the quality, safety, and/or favorability of the predicted subsequent state. If the quality, safety, and/or favorability of the estimated subsequent state satisfies a designated threshold (e.g., the candidate trajectory is predicted to result in a favorable, safe, desirable, and/or beneficial future state), the candidate trajectory may be used to control navigation. If not, a determination may be made to disengage autonomous navigation, execute a safety procedure, and/or a parameterized optimization may be used to generate an optimized trajectory using an optimized planner to iteratively refine a trajectory predicted to lead to the most desirable state—or at least a state beyond a threshold desirability.

### BACKGROUND

Machine learning has proven to be extraordinarily effective in learning complex input-to-output mappings. Early examples include character recognition or image classification (ImageNet), where traditional hand-crafted algorithms struggle while machine learning proved to be far superior. In other words, optimizing the internal values of a parameterized machine through example input/output data pairs and simple numerical optimization algorithms leads to better results than trying to achieve the same goal through manual programming. Over the last few decades, the amount of training data, the size of neural networks, and the available compute power have steadily increased, continuously pushing the complexity of the problems solved by machine learning and the value provided by those solutions. One recent example is large language models (LLMs), which essentially predict the most likely next word (or token) based on previous words. Trained with vast amounts of data, such simple setups become enormously valuable information retrieval systems whose outputs are often nearly indistinguishable from human-generated text.

Turning to the autonomous or semi-autonomous machine (e.g., autonomous vehicle (AV)) field, autonomous or semi-autonomous machines typically rely on perception data from sensors like cameras, LiDAR sensors, ultrasonic sensors, and/or RADAR sensors to understand the surrounding three-dimensional (3D) environment and a navigation (e.g., driving or control) policy implemented using machine learning to make navigation decisions such as turning, accelerating, and braking in various (e.g., driving, control, or navigation) scenarios. These components responsible for decision-making and actuation are sometimes referred to as a stack (e.g., a control stack or a drive stack in the context of autonomous or semi-autonomous driving). In earlier designs, machine learning was used to translate pixels to some hand-designed representation, typically bounding boxes for detected objects and polylines for detected parts of the environment like road boundaries or lane lines. More recently, industry leaders started to use end-to-end (E2E) learning combined with large-scale pretraining. End-to-end learning, in examples, directly maps raw sensor data (e.g., pixels, point clouds, etc.) to driving actions using a single, unified neural network or other machine learning model type/architecture, without decomposing or breaking down the decision-making process into modular, hand-designed stages. End-to-end systems may include multiple neural networks (or stacked sets of one or more neural network layers that individually perform a designated function), such as an image encoder followed by a parameterized neural planner (e.g., a learned planner) , and typically output a target trajectory(ies) or path(s) specifying or indicating the desired position, orientation, and velocity of the vehicle, and a traditional controller converts this information into actuation commands (e.g., throttle, brake, and steering). Common to conventional end-to-end systems is that they are trained with sensor-to-action or sensor-to-trajectory pairs (as opposed to detectors, which are typically trained with sensor-to-human designated output—such as bounding boxes, polylines, and/or other output representations).

End-to-end learning has led to better results, likely because of the avoidance of information loss (e.g., the model learns what is important to produce an accurate and precise output, as opposed to a human estimating what might be more useful to do the same). For example, human-designed representations such as object bounding boxes have inherent limitations, such as, for example, providing too much information in most cases (e.g., driving decisions seldom require the exact bounding box for every nearby vehicle) and providing too little information in some cases (e.g., a ladder protruding from the bed of a pickup truck can extend the detected bounding box of the pickup truck, making the truck appear larger than it really is). Large-scale pretraining typically involves self-supervised learning on vast, publicly available datasets (often referred to as “internet-scale”), followed by domain-specific fine-tuning with a smaller dataset.

Since end-to-end learning maps sensor data directly to action (or a corresponding trajectory(ies) or path(s)), existing end-to-end systems typically need to learn the mapping from all potentially relevant scenarios to corresponding actions (e.g., how to deal with a paper bag blown across the street as opposed to a wheel that fell off a truck, or how to deal with an open pothole as opposed to a closed pothole). In other words, existing techniques for training end-to-end systems rely on developing a very long internal table of scenario-to-action pairs, often resulting in undesired actions for unknown scenarios—e.g., forcing a disengagement event, swerving around an object when unnecessary (such as a paper bag), etc. Since the variety and magnitude of all possible scenarios an autonomous or semi-autonomous vehicle should be able to handle is extremely large, it is likely unfeasible to learn all the relevant scenarios, given practical constraints on data availability, memory capacity, and computational resources. At a minimum, end-to-end learning alone does not appear to be the most efficient way of solving the problem.

As a result, there is a need for improved techniques for determining which actions autonomous or semi-autonomous machines—such as self-driving vehicles, robots, and drones—should take.

### SUMMARY

Embodiments of the present disclosure relate to a modular control (e.g., drive) stack—that may use end-to-end (E2E) learning—with projection and evaluation of scene states for autonomous and semi-autonomous systems and applications. Systems and methods are disclosed that evaluate—at some or all iterations—candidate trajectories by predicting the subsequent scene or world state that would result, and quantifying a measure of the quality or favorability of the predicted subsequent state. As such, the measure of quality or favorability may be used to determine whether to use the candidate trajectory and/or whether to generate an optimized trajectory. In instances where the world state is unfavorable for a candidate trajectory, this information may be stored for performing updates to the neural network(s) (e.g., including an E2E neural network(s)) included in the stack.

In contrast to conventional systems, an existing stack (e.g., control stack, drive stack, etc., which may include hardware and/or software components) of an ego-machine such as an end-to-end control stack may be used to generate a candidate trajectory, a deep neural network (DNN) (e.g., a stochastic neural network) may be used to generate a latent representation of an estimated future scene state that would result from taking the candidate trajectory, and a state evaluation network may be used to evaluate the quality or favorability of the estimated future state. If the estimated future state of the scene satisfies a designated threshold (e.g., the candidate trajectory is predicted to result in a favorable or beneficial future state), the candidate trajectory may be used to control navigation of the ego-machine. In some embodiments, if the estimated future scene state does not satisfy the designated threshold, a determination may be made not to engage autonomous or semi-autonomous features—such as for navigation.

In some embodiments, if the estimated future scene state does not satisfy a designated threshold, a parameterized optimization may be used to generate an optimized trajectory using the state evaluation network as the cost function. For example, a parameterized planner, a parameterized optimization, future state estimation, and state evaluation may operate in a loop as an optimal planner, iteratively refining a trajectory predicted to lead to the most desirable state. In some embodiments, to accommodate the additional time to run one or more iterations of the optimization loop, the ego-machine may be slowed down to accommodate the longer processing time (much like humans slow down their vehicle when encountering an unknown situation). In some embodiments, the scenarios in which the optimized planner was engaged (e.g., scenarios in which the candidate trajectory predicted by the existing control stack did not satisfy the designated threshold) and/or scenarios in which the ego-machine was slowed down may be used to generate training data to improve the existing control stack and/or other control stacks or planners.

As such, the present techniques may be used to control navigation of autonomous or semi-autonomous machines, vehicles, robots, and/or other object or machine types.

### BRIEF DESCRIPTION OF THE DRAWINGS

The present systems and methods for a modular (e.g., drive, control, etc.) stack—which may use end-to-end learning—with projection and evaluation of scene state for autonomous or semi-autonomous systems and applications are described in detail below with reference to the attached drawing figures, wherein:

FIG. 1 is a data flow diagram illustrating an example control stack that predicts and evaluates future scene states, in accordance with some embodiments of the present disclosure;

FIG. 2 is a data flow diagram illustrating an example control stack that optimizes a trajectory to lead to a predicted favorable or beneficial future scene state, in accordance with some embodiments of the present disclosure;

FIG. 3 is a flow diagram showing a method for determining whether to use a candidate trajectory to control navigation of an ego-machine based at least on a measure of estimated favorability of an estimated future world state, in accordance with some embodiments of the present disclosure;

FIG. 4A is an example of sensor locations having corresponding fields of view or sensory fields for example autonomous or semi-autonomous machines, in accordance with at least some embodiments of the present disclosure;

FIG. 4B is an illustration of an example of component and sensor locations on an autonomous or semi-autonomous vehicle, in accordance with at least some embodiments of the present disclosure;

FIG. 4C is a block diagram of an example system architecture for an autonomous or semi-autonomous vehicle, robot, and/or other machine type, in accordance with at least some embodiments of the present disclosure;

FIG. 4D is a block diagram of an example architecture of a computing system—such as a system-on-a-chip (SoC)—in accordance with at least some embodiments of the present disclosure;

FIG. 4E is a system diagram for communication between cloud-based server(s) and an example autonomous or semi-autonomous vehicle, robot, and/or other machine type, in accordance with at least some embodiments of the present disclosure;

FIG. 5 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 6 is a block diagram of an example computing system for generative artificial intelligence (AI), in accordance with at least some embodiments of the present disclosure; and

FIG. 7 is a block diagram of an example computing device, in accordance with at least some embodiments of the present disclosure.

### DETAILED DESCRIPTION

Systems and methods are disclosed relating to a modular (e.g., drive, control, software, hardware, software and hardware, etc.) stack—that may use end-to-end machine learning projection and evaluation of scene state for autonomous and semi-autonomous systems and—with applications. For example, a candidate trajectory generated using an end-to-end stack, processing pipeline, process, etc., may be used to predict the subsequent scene or world state that would result from that candidate trajectory, and the predicted scene or world state may be evaluated and used to determine whether to use the candidate trajectory and/or whether to generate an optimized trajectory. The present techniques may be used to aid in generating, or may directly output, control or navigation commands of autonomous or semi-autonomous vehicles, machines, robots, drones, watercraft, aircraft, and/or other object or machine types, and/or may be used to generate training data to improve an end-to-end stack, processing pipeline, process, etc.

Although primarily described herein as a stack, control stack, or driving stack, this is not intended to be limiting, and the systems and methods described herein may alternatively be referred to as a processing pipeline, a process, a control stack, a driving stack, a software stack, a hardware/software stack, etc., without departing from the scope of the present disclosure.

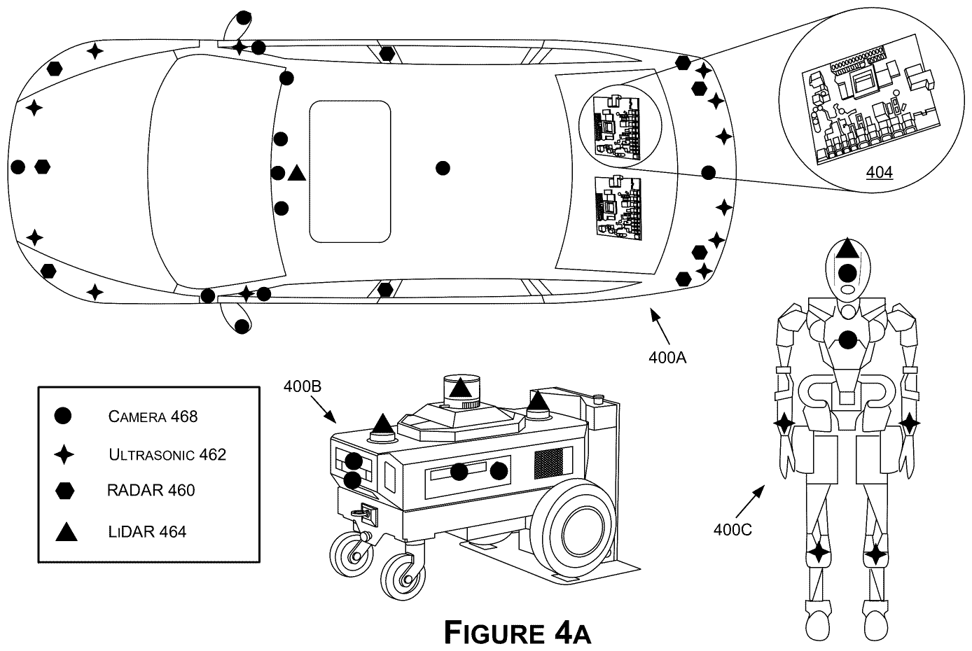

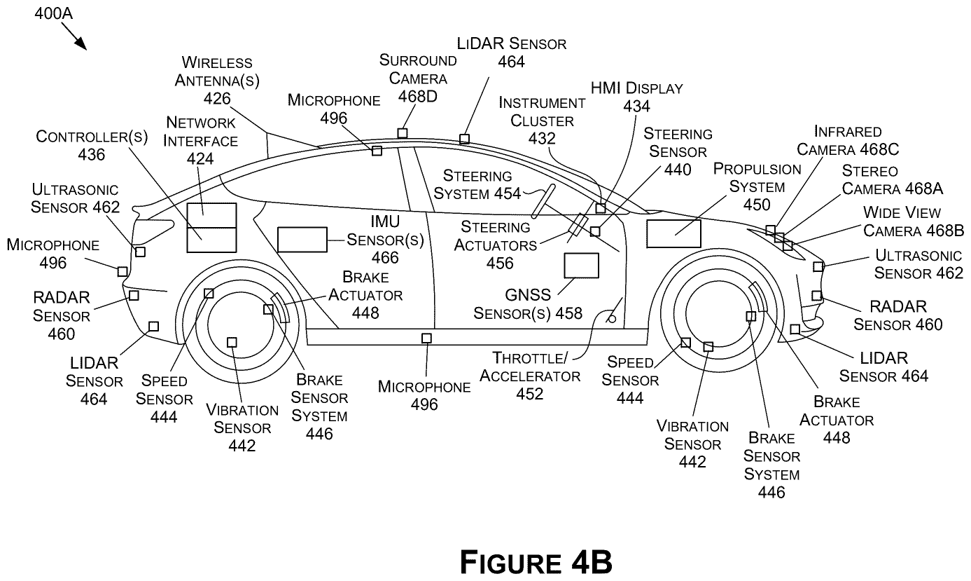

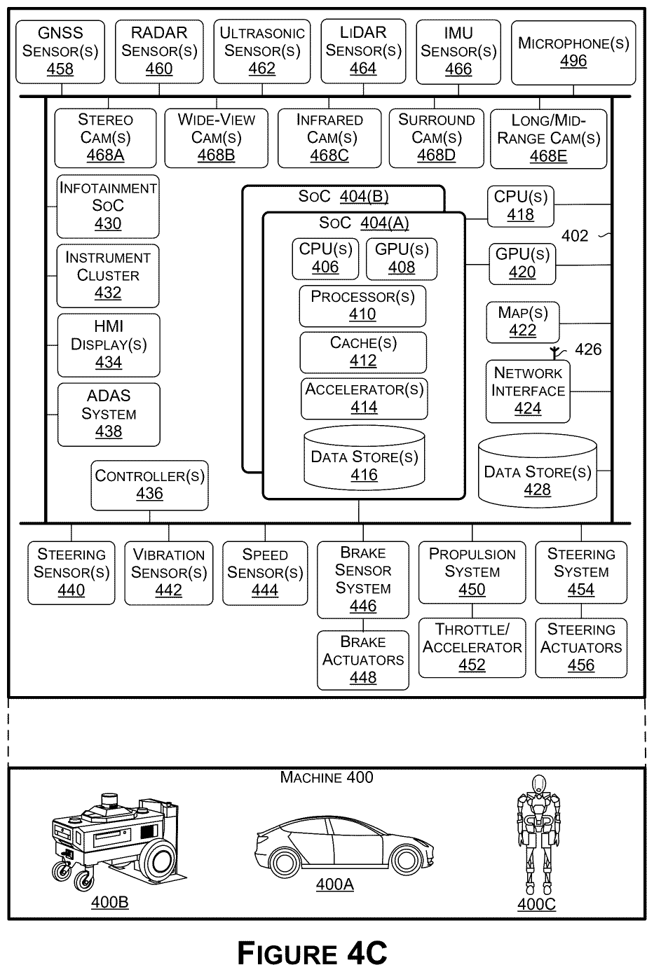

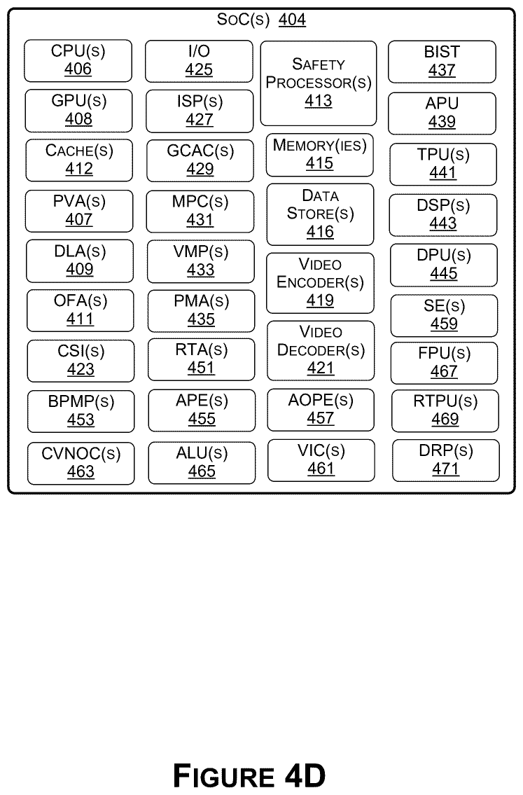

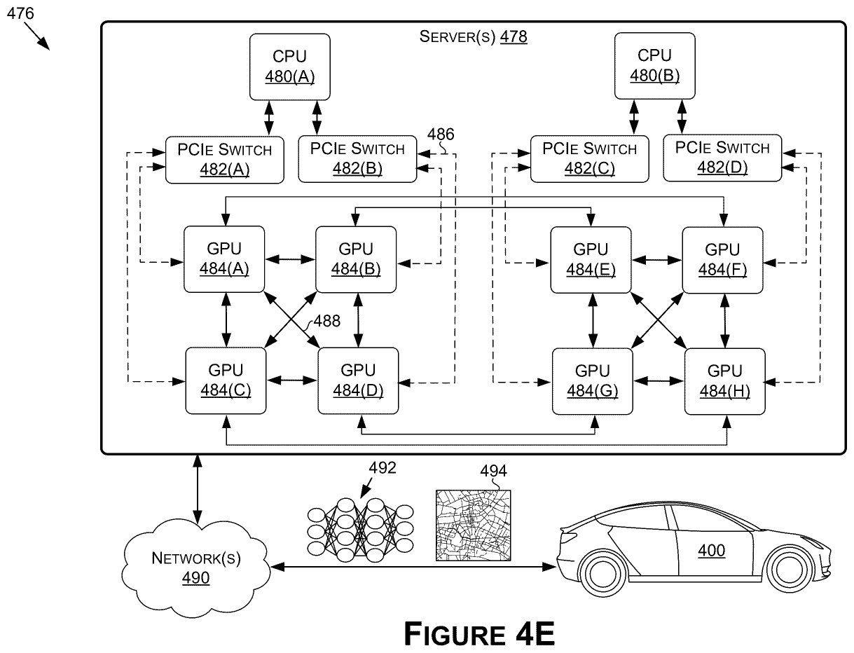

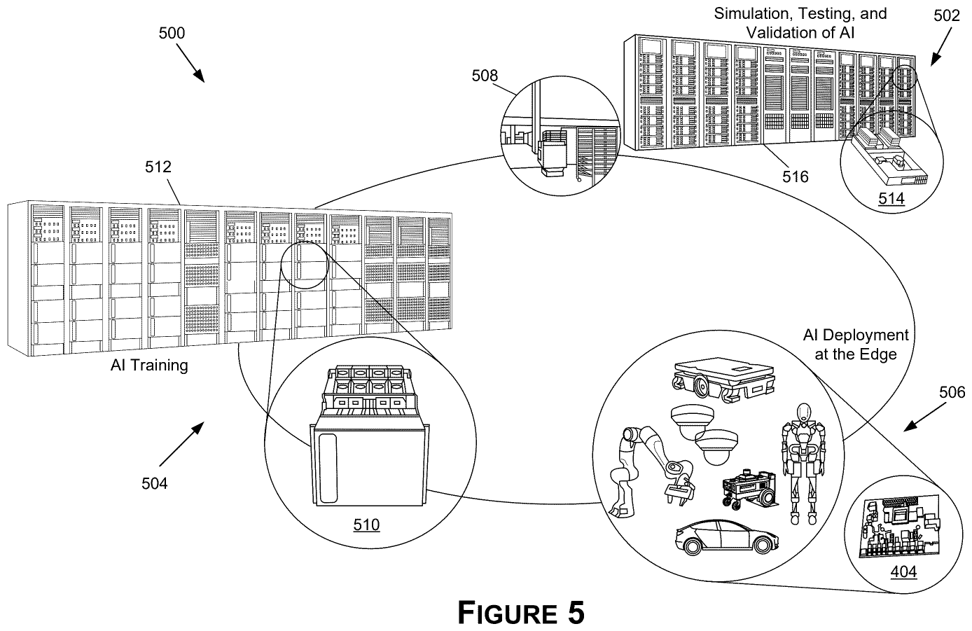

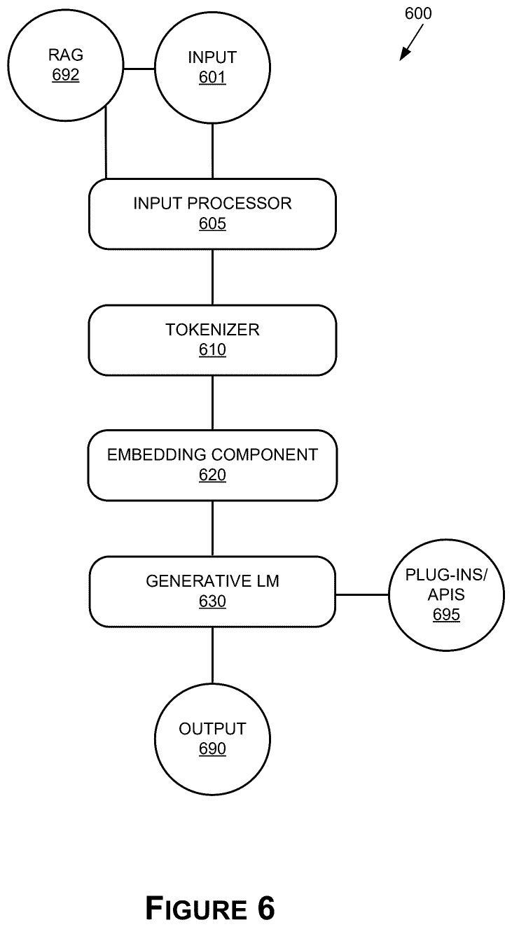

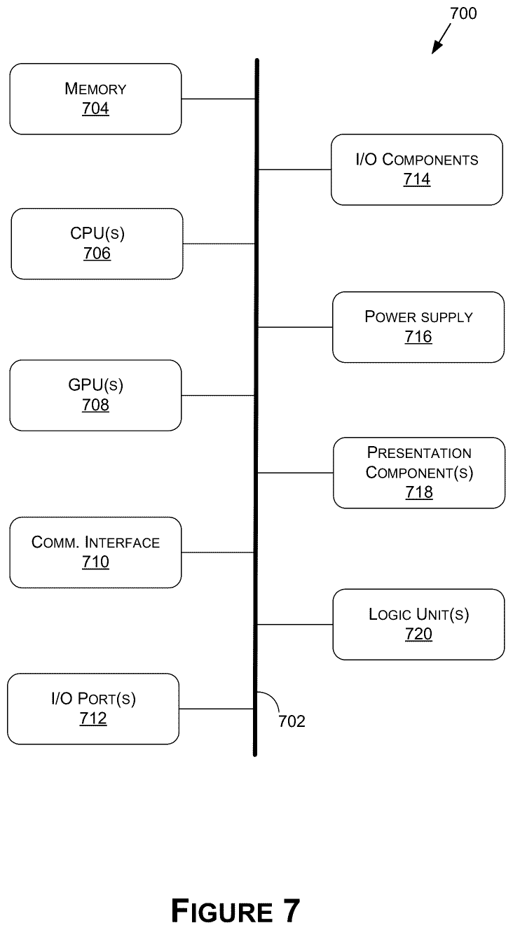

Although the present disclosure may be described with respect to an example autonomous or semi-autonomous vehicle, robot, and/or other machine type 400 (alternatively referred to herein as “vehicle 400,” “ego-vehicle 400,” “machine 400,” “ego-machine 400,” “robot 400,” and/or “ego-robot 400,” an example of which is described with respect to FIGS. 4A-4E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to navigation control for autonomous driving, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where navigation control may be used. In some embodiments, the systems, methods, and/or processes described herein may be executed using similar components, features, and/or functionality to those of example machine 400 of FIGS. 4A-4E, example computing ecosystem 500 of FIG. 5, example generative language model system 600 of FIG. 6, and/or example computing device 700 of FIG. 7.

In some embodiments, an existing control stack—such as an end-to-end control stack—may be used to generate a candidate trajectory, a deep neural network (DNN) (e.g., a stochastic neural network) may be used to project a representation of an aggregate history of the scene and the candidate trajectory into a latent space and generate a prior distribution representing an estimated future state of the scene that would result from taking the candidate trajectory. In embodiments, this DNN may be referred to as the world model DNN, world model neural network, or world model machine learning model. The most likely state(s) may be sampled from the predicted distribution, and a state evaluation network may be used to evaluate the favorability, safety, and/or quality of the estimated future state(s). If the estimated future state of the scene satisfies a designated threshold (e.g., the candidate trajectory is predicted to result in a favorable, safe, and/or beneficial future state), the candidate trajectory may be used—or at least considered in a set of trajectories—to control navigation. In some embodiments, if the estimated future state of the scene does not satisfy the designated threshold, a determination may be made not to engage autonomous or semi-autonomous navigation (or to disengage autonomous navigation). Disengagement may include full handover to a human driver (e.g., disengaging all autonomous and/or semi-autonomous functionality), executing a safety procedure (e.g., slowing down to a stop, pulling to side of the road, etc.) at least until an updated safe, beneficial, or favorable state is achieved, and/or disengage or turn off one or more autonomous or semi-autonomous features (e.g., disable system initiated lane changes (SILC) or adaptive cruise control (ACC) until an updated safe, beneficial, or favorable state can be achieved).

In some embodiments, if the estimated future state of the scene does not satisfy a designated threshold, a parameterized optimization may be used to generate an optimized trajectory using the state evaluation network as the cost function. For example, if the candidate trajectory was generated using a parametrized planner in the existing control stack, a second instance of the parameterized planner may be optimized using the estimated favorability of the estimated future state (e.g., using gradients computed by back-propagating the estimated favorability of the estimated future state back to the parameterized planner in the existing control stack), the second instance of the parameterized planner may be used to predict an alternate candidate trajectory, this alternate candidate trajectory may be passed back to the world model DNN to predict an alternate future state, the state evaluation network may be used to evaluate the favorability of the alternate future state, and the designated threshold may be applied to the estimated favorability of the alternate future state.

In another example (e.g., if the initial candidate trajectory was generated using a first parametrized planner in the existing control stack that is different from a second parameterized planner used to predict an alternate candidate trajectory), the second parameterized planner may be used to predict an alternate candidate trajectory from the current state of the scene (e.g., and a representation of its estimated favorability), the alternate candidate trajectory may be applied to the world model DNN to predict an alternate future state, and the state evaluation network may be used to evaluate the favorability of the alternate future state. This scenario may be used to implement a specialized network architecture for each purpose (e.g., one architecture to produce a trajectory that is almost always correct and another architecture to produce alternative trajectories quickly for the cases where the first planner is incorrect—or at least produces a trajectory(ies) that is below the threshold for safety, favorability, etc.). In some embodiments, the designated threshold may be used to test the estimated favorability of the alternate future state, and if the estimated favorability of the alternate future state of the scene satisfies the designated threshold, the alternate candidate trajectory may be used to control navigation.

In some embodiments (e.g., if the estimated favorability of the alternate future state of the scene generated using either of the techniques described above does not satisfy the designated threshold), the gradients of the estimated favorability of the alternate future state may be computed with respect to the parameters of the second parameterized planner (e.g., by back-propagating the estimated favorability of the alternate future state back to the second parameterized planner), the gradients may be used to update the second parameterized planner, the updated parameterized planner may be used to generate an improved modification to the alternate candidate trajectory, and this improved candidate trajectory may be passed back to the world model DNN and state evaluation network for a subsequent evaluation. If the estimated future state of the scene that would result from taking the optimized candidate trajectory satisfies the designated threshold (e.g., the optimized candidate trajectory is predicted to result in a favorable future state), the optimized candidate trajectory may be used—or at least considered in a set of trajectories—to control navigation. If the estimated future state of the scene does not satisfy the designated threshold, the optimization may iterate in one or more additional passes of the loop, for example, until a designated convergence criterion is satisfied (e.g., until the optimized candidate trajectory is predicted to result in an estimated future state that satisfies the designated threshold).

As such, a parameterized planner, a parameterized optimization, future state estimation, and/or state evaluation may operate in a loop as an optimized planner, iteratively refining a trajectory predicted to lead to the most desirable state—or at least a state that is beyond a designated threshold or thresholds. In some embodiments, to accommodate the additional time to run one or more iterations of the optimization loop, the vehicle (or other ego-machine type) may be slowed down (e.g., as part of a safety maneuver) to accommodate the longer processing time (much like humans slow down their vehicle when encountering an unknown situation).

In some embodiments, the scenarios in which the optimized planner was engaged (e.g., the candidate trajectory predicted by the existing control stack did not satisfy the designated threshold) and/or scenarios in which the machine was slowed down may be used to generate training data to improve the existing control stack. For example, if a candidate trajectory predicted by a learned planner of an end-to-end control stack results in an estimated state that fails to meet a designated threshold, the vehicle (or other ego-machine) is likely in a situation it was not trained to handle, and it is likely to remain that way for some number of consecutive time slices (e.g., corresponding 10 Hertz or 100 millisecond decisions). For example, if the vehicle encounters a tree branch in the road and that scenario was not reflected in its training data, in order to make a plan to get around the branch, it may take ten, twenty, or fifty time slices before the vehicle is clear of the branch, during which the optimized planner may be engaged. As such, the optimized trajectories and/or actions generated by the optimized planner and corresponding sensor data may be recorded, included in a training dataset, and used to train the learned planner of the end-to-end control stack. As such, the learned planner of the end-to-end control stack should learn to generate better trajectories and actions over time, resulting in more efficient systems (e.g., that have less and less scenarios in which they slow down), while at the same time being able to adapt in real-time to the previously unseen scenario using the iterative loop of the stack. In this way, previously unseen or challenging scenarios may be safely navigated by the machine using the iterative loop process, and the data may then be stored and used later to fine-tune or update the stack such that less processing time and compute is required the next time the scenario (or a similar scenario) is encountered.

As such, the present techniques may be used to control navigation of autonomous vehicles, semi-autonomous vehicles, machines, robots, and/or other object or machine types. Estimating and evaluating a projected future state that would result from a candidate trajectory and/or optimizing a trajectory that results in a favorable projected future state effectively constitutes an efficient decomposition that avoids both the limits of hand-designed representations and the need to develop a very large scenario-to-action table. As such, the present techniques may be used to increase the accuracy, precision, and performance of control stacks, drive stacks, software stacks, software/hardware stacks, end-to-end processing pipelines, etc., while simultaneously increasing safety and reducing a number of disengagement events for the machine.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine a trajectory or control actions, etc., and this information may be used to perform operations associated with the virtual machine (e.g., to control navigations of a simulated machine) within the simulation environment. These simulated operations may be used to test performance of the underlying algorithms, systems, and/or processes prior to deploying them in the real-world. In some instances, the simulation may be used to generate synthetic training data—e.g., representing simulated scenarios in which an optimized planner was used to control navigation within the simulated environment. The synthetic training data (in addition to or alternatively from real-world data) may then be used or processed to train and test various planners or other types of machine learning models.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to generate proposed trajectories and/or control actions that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed to control navigation in a robotics application. A robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, one or more machine learning models, entertainment content, navigation data, user preferences, etc.). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be used to present a visual representation of a generated trajectory or control actions via an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

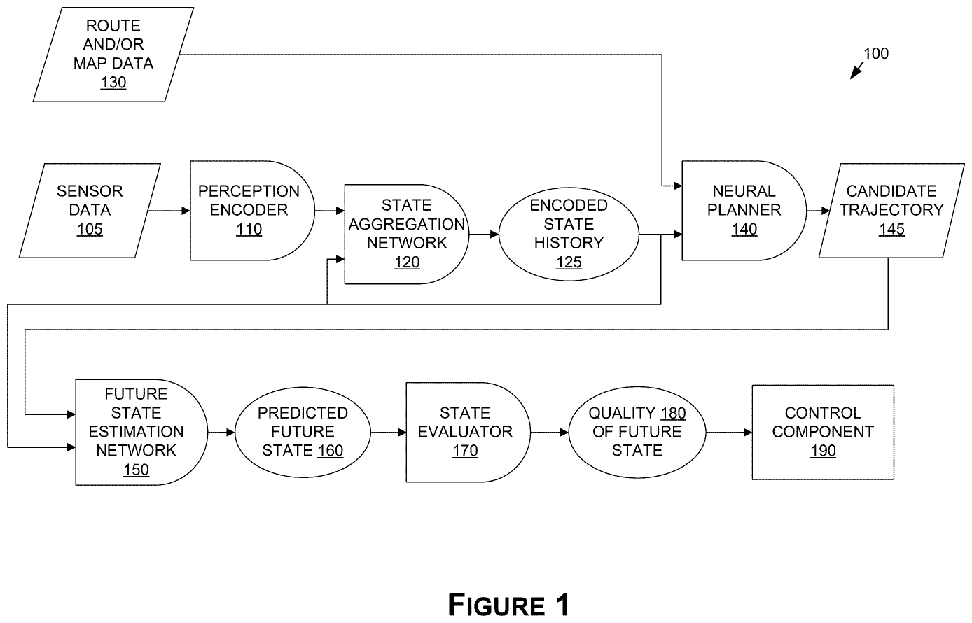

With reference to FIG. 1, FIG. 1 is a data flow diagram illustrating an example control stack 100, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 400 of FIGS. 4A-4E, example computing ecosystem 500 of FIG. 5, example generative language model system 600 of FIG. 6, and/or example computing device 700 of FIG. 7.

Generally, the control stack 100 may be deployed in—or may otherwise be accessible to or used to control—a real or simulated ego-machine (e.g., the autonomous or semi-autonomous vehicle, robot, or machine 400 of FIGS. 4A-4E). Although primarily described herein as a stack, control stack, or driving stack, this is not intended to be limiting, and the systems and methods described herein may alternatively be referred to as a processing pipeline, a process, a control stack, a driving stack, a software stack, a hardware/software stack, etc., without departing from the scope of the present disclosure.

In the example illustrated in FIG. 1, the control stack 100 includes an end-to-end (E2E) control stack formed by a perception encoder 110, a state aggregation network 120, and a neural planner 140, which may be used to generate a candidate trajectory 145 and/or control actions from sensor data 105. A future state estimation network 150 (also referred to as a world model neural network) may project a representation of an aggregate history of the scene and the candidate trajectory 145 and/or control actions into a latent space and generate a prior distribution representing an estimated future state of the scene that would result from taking the candidate trajectory 145 and/or control actions. As such, a state evaluator 170 may sample a predicted future state 160 from the predicted distribution and generate a representation of the quality 180 (or favorability) of the predicted future state 160. As such, a control component 190 of the ego-machine may compare the quality 180 of the predicted future state 160 to a designated threshold, and if the quality 180 of the predicted future state 160 satisfies the designated threshold (e.g., the candidate trajectory 145 and/or control actions is predicted to result in a favorable or beneficial future state), the control component 190 may use (or at least consider) the candidate trajectory 145 and/or control actions to control navigation of the ego-machine. The control stack 100 may operate at any suitable frame rate (e.g., 30 fps, 45 fps, 60 fps, etc.). For example, a frame(s) of the sensor data 105 may be generated for each time slice, and the control stack 100 may use the frame(s) of sensor data 105 for each time slice to generate a trajectory and/or control actions and may use the generated trajectory and/or control actions to control the ego-machine (whether at the same frame rate as the sensor data 105 is generated or some other frame rate).

Generally, the control stack 100 may use sensor data 105 from any number and/or any type of sensor, such as, without limitation, one or more cameras, LiDAR sensors, RADAR sensors, ultrasonic sensors, and/or other sensor types, such as those described below with respect to the autonomous or semi-autonomous machine 400 of FIGS. 4A-4E, and the control stack 100 may process the sensor data 105 into a format the perception encoder 110 accepts. In some embodiments, the sensor(s) may be deployed with an ego-machine and may be used to generate a frame(s) of sensor data 105 that represent a 3D environment the ego-machine is navigating. For example, the sensor data 105 may include one or more images from one or more cameras (e.g., N images from N cameras such as surround view cameras, a stitched image), and may be stacked, concatenated, or otherwise combined in any suitable way. Additionally or alternatively, in some embodiments in which the sensor data 105 includes a representation of measured 3D points (e.g., LiDAR or RADAR point clouds), the control stack 100 may accumulate the measured 3D points (e.g., over a designated number of time slices, LiDAR or RADAR spins, etc.), transform the measured 3D points to a single coordinate system (e.g., centered around an origin of a rig coordinate system of the ego-machine), ego-motion-compensate the measured 3D points (e.g., to a latest known position of the ego machine), and/or project the measured 3D points to form a projection image representing any suitable view of the 3D environment (e.g., perspective, orthographic), having any number of channels (e.g., a single channel image, a multi-channel image or tensor) representing any characteristic of the sensor data 105 (e.g., projected position of a measured 3D point, one or more reflection characteristics, image data such as pixel color, etc.). For example, an (accumulated, ego-motion-compensated) LiDAR point cloud may be projected to form a LiDAR range image with a perspective view or a top-down (e.g., bird's eye view (BEV)) representation of projected 3D locations of measured 3D points (e.g., an elevation map), with any number of channels (e.g., storing reflection characteristics such as intensity, elevation or range profile, etc.). In some embodiments, different sensor(s) (whether the same type or a different of sensor) may be used to generate different modalities of sensor data 105 (e.g., camera images, LiDAR range images, etc.) having the same (e.g., perspective) view of the 3D environment in a common image space, and sensor data 105 from the different sensors and/or sensor modalities may be stored in different channels of a multi-channel image or tensor. These are meant simply as examples, and any suitable representation of the 3D environment and/or the state of the ego-machine may be used as at least a portion of the sensor data 105.

Generally, the perception encoder 110 may be implemented using any type of machine learning model or neural network (e.g., a backbone network, feature extractor, etc.) such as those described herein. For example, the perception encoder 110 may include, without limitation, a feature extractor (e.g., a deep neural network (DNN), an encoder/decoder, etc.) including convolutional layers, transformer layers, pooling layers, and/or other layer types, and the perception encoder 110 may be used to extract a latent representation of the state of the scene represented by the sensor data 105 (e.g., a scene embedding representing the 3D environment).

The state aggregation network 120 may accept this latent state of the scene as input and generate an encoded state history 125. Generally, the state aggregation network 120 may be implemented using any known machine learning model or neural network, such as a gated recurrent unit (GRU) recurrent neural network (RNN), long short-term memory (LSTM), transformer, temporal convolutional network (TCN), or another sequence-based model which may serve as a memory mechanism. By operating the state aggregation network 120 sequentially, the state aggregation network 120 may effectively aggregate or accumulate previous latent states (before time t) deterministically using a hidden state of the state aggregation network 120, sequentially updating the memory mechanism at each time slice based on the latent representation of the sensor data 105 extracted by the perception encoder 110 for the current time slice and the previous hidden state of the network. As such, the encoded state history 125 may be provided to the neural planner 140 and the future state estimation network 150.

Generally, the neural planner 140 may be implemented using any type of machine learning model or neural network such as those described herein and may be used to predict or generate a candidate trajectory 145 and/or control actions from the encoded state history 125. For example, the neural planner 140 may predict any suitable representation of a candidate trajectory 145 (e.g., a sequence of future waypoints with associated timestamps, positions, velocities, and/or accelerations) and/or candidate control action(s) or actuation command(s) (e.g., steering angles, acceleration or throttle, brake pressures, high-level navigation decisions such as changing lanes, merging, or stopping at intersections, motor or actuator controls for robotic movements, grasping, manipulation (e.g. using end-effectors, robotic arms, etc.), etc.). The neural planner 140 may additionally or alternatively accept other types of inputs such as route and/or map data 130 (e.g., representing a planned navigation route, a map of the environment such as the High Definition (“HD”) map 422 of FIG. 4C or other map information 494, a representation of detected features of a navigable surface such as a rasterized lane graph; high-level route guidance (e.g., change lanes as soon as possible), etc.), an ego-state of the ego-machine (e.g., a detected position, orientation, speed, ego-motion, etc.), a history of actions taken by the ego-machine, and/or otherwise.

For example, a route planner of the control stack 100 may generate a planned navigation route using any known technique (e.g., any path-planning algorithm) and may represent the planned navigational route in a variety of ways (e.g., a rasterized binary mask visualizing a (e.g., top-down) view of a planned trajectory; a sequence of 2D waypoints; a list, array, queue, or other representation of a sequence of navigation routing commands (e.g., turn right in 100 feet, continue straight for 30 miles, take a left turn at the next stop light) which may be encoded using one-hot encoding, embedding vectors, RNN(s) to handle sequential processing, positional encodings and transformers, etc.), and a featurizer (e.g., implemented using any type of the machine learning model or neural network, such as those described herein) may be used to generate a corresponding embedding. In some embodiments, a state detection component of the control stack 100 may generate a representation of one or more states of the ego-machine. For example, ego-machine speed may be estimated (e.g., using a speed sensor(s), a Global Positioning System (GPS), etc.) and encoded into a speed embedding. In some embodiments, a representation of the ego-motion (e.g., speed, relative pose) of the ego-machine may be detected (e.g., estimated using a speed sensor(s) or GPS) or generated (e.g., by taking the difference between successive detected ego-poses), and a corresponding featurizer (e.g., implemented using any type of the machine learning model or neural network, such as those described herein) may be used to generate a corresponding embedding. These are just a few examples, and other components of a detected ego-state (e.g., represented by GPS data, IMU data, and/or otherwise) may additionally or alternatively be featurized.

As such, the neural planner 140 may accept a representation of the encoded state history 125, the route and/or map data 130, ego-state of the ego-machine, and/or other types of inputs, and may use any known technique to generate a candidate trajectory 145 and/or control actions from those input(s). Although the embodiment illustrated in FIG. 1 includes a neural planner, a navigation policy may be implemented using any known technique, such as those that apply one or more human-defined or formulated rules or heuristics to make navigation decisions (classical planners), those that use neural network(s) to predict or generate a planned trajectory or action (neural planners), those that use a traditional controller to implement classical control algorithms like model predictive control (MPC), some combination thereof (e.g., a neural or classical planner that predicts an action followed by a classical control algorithm that optimizes the predicted action), and/or otherwise. For example, a navigation policy may use the neural planner 140 or a classical planner to predict the candidate trajectory 145 (e.g., instead of directly predicting acceleration and steering), and the control component 190 may use MPC to account for ego-machine dynamics, using the candidate trajectory 145 as a reference to follow or guide its control actions. As such, a representation of the candidate trajectory 145 and/or control actions may be provided to the lower branch of FIG. 1 to predict and evaluate the quality of the state that would result from taking the candidate trajectory 145 and/or control actions.

More specifically, a (e.g., trajectory) evaluation network comprising the future state estimation network 150 and the state evaluator 170 may be used to predict and evaluate the quality of the state that would result from taking the candidate trajectory 145 and/or control actions. The following discussion will use evaluation of a candidate trajectory 145 and/or control actions predicted by the neural planner 140 as an example, but other variations may be implemented. For example, the upper branch of the control stack 100 and/or the control stack 200 may include a classical planner that generates a candidate trajectory, and the lower branch may evaluate the candidate trajectory generated by the classical planner. In some embodiments, a classical or neural planner may generate a trajectory, a classical control algorithm may use the trajectory to generate optimized control actions, and the lower branch may evaluate the trajectory and/or control actions. In some embodiments, a classical or neural planner may generate a trajectory, the lower branch may evaluate the trajectory, and the control component 190 may implement a classical control algorithm to generate an optimized control action based on the trajectory. These are just a few examples, and other variations are contemplated within the scope of the present disclosure.

In the example illustrated in FIG. 1, the future state estimation network 150 (or world model neural network) accepts a representation of the candidate trajectory 145 (and/or control actions) and the encoded state history 125 as input and projects the input into a latent representation of the predicted future state 160 of the scene. Generally, the future state estimation network 150 may be implemented using any type of neural network or other machine learning model such as those described herein. For example, the future state estimation network 150 may include a generative DNN such as one or more stochastic neural networks (e.g., Bayesian neural network(s), variational autoencoders (VAEs)) that predict a state distribution (or world model) that models a range of possible (estimated future) scene or world states. More specifically, the future state estimation network 150 may model stochastic latent space world transitions from t−1 to t conditioned on the encoded state history 125, the candidate trajectory 145 and/or control actions, and/or other inputs (e.g., the route and/or map data 130, ego-state of the ego-machine, a history of actions taken by the ego-machine, etc.). Accordingly, the future state estimation network 150 may predict parameters of a (e.g., Gaussian) distribution of possible latent states, and the state evaluator 170 may sample from the distribution to generate a prior (estimated future) latent state sample representing the estimated future state. For example, the future state estimation network 150 may predict a multi-dimensional latent distribution parameterized by a mean vector and covariance (or variance) per latent cell, and the state evaluator 170 may identify the most likely state or states for each latent cell. For a single-mode Gaussian distribution, the state evaluator 170 may sample the most likely state by selecting the predicted mean values as the most probable latent state. For more complex or multimodal distributions, the state evaluator 170 may identify the most likely state(s) using any known mode-seeking technique, and the latent representation(s) of the most likely identified state(s) may be combined using any suitable technique (e.g., averaging).

As such, the latent representation of the most likely state(s) may be used as the predicted future state 160 and evaluated by the state evaluator 170 to generate a representation of the quality 180 (or favorability) of the future state. Generally, the state evaluator 170 may be implemented using any type of machine learning model or neural network such as those described herein. For example, the state evaluator 170 may use any known regression or classification technique to generate a measure of the predicted quality, safety, favorability, or other state indicating an acceptability or desirability of the future state. By way of nonlimiting example, the state evaluator 170 may regress a floating-point scalar value (e.g., normalized over some range of values such as zero to ten, with zero representing the best possible state and ten representing the worst possible state) or may classify the predicted future state 160 into one of a plurality of discretized bins representing different measures of quality or favorability (e.g., by generating classification scores for each bins and taking the measure of quality or favorability corresponding to the bin with the highest classification score). As such, the state evaluator 170 may extract a measure of the quality 180 (e.g., quality, favorability, desirability, safety, and/or other measure) of the predicted future state 160 and provide it to the control component 190.

As such, the control component 190 may compare the quality 180 of the predicted future state 160 to a designated threshold, and if the quality 180 of the predicted future state 160 satisfies the designated threshold (e.g., the candidate trajectory 145 is predicted to result in a favorable or beneficial future state), the control component 190 may use the candidate trajectory 145 and/or control actions to control navigation of the ego-machine. In some embodiments, the control component 190 may use control actions predicted by the neural planner 140 (e.g., steering angles, acceleration or throttle, brake pressures, high-level navigation decisions such as changing lanes, merging, or stopping at intersections) as actuation commands. In some embodiments, the control component 190 may use a traditional controller to convert the candidate trajectory 145 predicted by the neural planner 140 into corresponding control actions and may use those control actions as actuation commands.

In some embodiments, if the quality 180 of the predicted future state 160 does not satisfy the designated threshold, the control component 190 may make a determination not to engage autonomous navigation (e.g., if the evaluation was associated with a request to transition to autonomous navigation) or may determine to disengage autonomous navigation (e.g., if autonomous navigation is already engaged). If disengaging autonomous navigation, the control component 190 may trigger one or more alerts (auditory, visual, or haptic) to gain the operator's attention and may coordinate with a driver or operator monitor system to assess the operator's attention using any known technique. If the operator is alert and ready to assume control, the control component 190 may transition control to the operator (e.g., by gradually deactivating autonomous functions). If the operator is inattentive or unresponsive, the control component 190 may adjust one or more operator assistance features such as adaptive cruise control (e.g., increase the following distance or reduce the vehicle's speed) or lane keeping assistance (e.g., be more proactive in correcting lane deviations), and/or trigger an ADAS to execute one or more safety interventions (e.g., automatic braking, emergency steering, autonomically pulling the vehicle over), etc.

As such, the control stack 100 may be deployed in an ego-machine and/or otherwise used to control navigation of the ego-machine. For example, the control stack 100 may run in real-time on a system-on-chip (which may correspond to the SoC(s) 404 of FIG. 4C) of an ego-machine (e.g., an automotive SoC such as NVIDIA's DRIVE Orin™ SoC, which may serve as a central computer for in-vehicle computing). Other types of SoCs which may be used in robots or ego-machines include AI-optimized SoCs (e.g., NVIDIA Jetson Series), robotics SoCs (e.g., for robotics applications such as drones, service robots, or industrial robots), industrial SoCs (e.g., for industrial robots or automation systems for factory automation, robotics, or control systems), drone and unmanned aerial vehicle (UAV) SoCs (e.g., for handling flight control, navigation, and/or real-time video processing), and/or others.

In embodiments in which the control stack 100 includes one or more machine learning models (e.g., an end-to-end control stack formed by the perception encoder 110, the state aggregation network, and the neural planner 140), the machine learning model(s) may be trained using any known technique. For example, the perception encoder 110 may be trained with any number of auxiliary task(s) that generate a training signal (loss function) (e.g., image classification, object detection, or end-to-end learning) and/or may be trained self-supervised (e.g., implemented using any type of auto-encoder that learns to reproduce an input through a compact latent representation). The end-to-end control stack may be trained using behavior cloning, imitation learning, and/or reinforcement learning with expert demonstrations, minimizing planning loss to ensure smooth trajectory generation, adding perturbations that intentionally place the ego-machine in bad states and providing a representation of how the ego-machine should recover, and/or otherwise. The future state estimation network 150 may be trained self-supervised using any number of temporal recordings of sequences of sensor data 105 (e.g., videos). For example, since world model neural networks are likely to be trained more efficiently in feature space, one or more auxiliary feature extractors may be used to extract sequences of latent representations of the sensor data 105, and the future state estimation network 150 may be trained self-supervised using the extracted sequences. The state evaluator 170 may be trained using training data representing world scene states labelled with corresponding measures of quality or favorability (e.g., labeling good states with ground truth classification or regression values representing high quality or favorable states, labeling bad states with ground truth classification or regression values representing low quality or unfavorable states). For example, almost any state in which a human navigated (e.g., drove a vehicle) and that did not lead to an accident may be labelled as a good state. Accidents and the short term before them may be labelled as undesirable states. Additionally or alternatively, human disengagements of deployed autonomous navigation may be labelled as bad states. In some embodiments, to handle situations in which there may be an unequal distribution of good and bad states represented in the training data, techniques such as those that use energy-based models may be used to train the state evaluator 170 to distinguish between observed and unobserved states (e.g., by assigning lower energy values to seen states and higher energy values to unseen or unlikely states) and learn that any observed state is good while anything not observed is bad. As such, the control stack 100 may be trained to generate and evaluate candidate trajectories and/or control actions and to control navigation using trajectories and/or control actions that are predicted to result in the most favorable states.

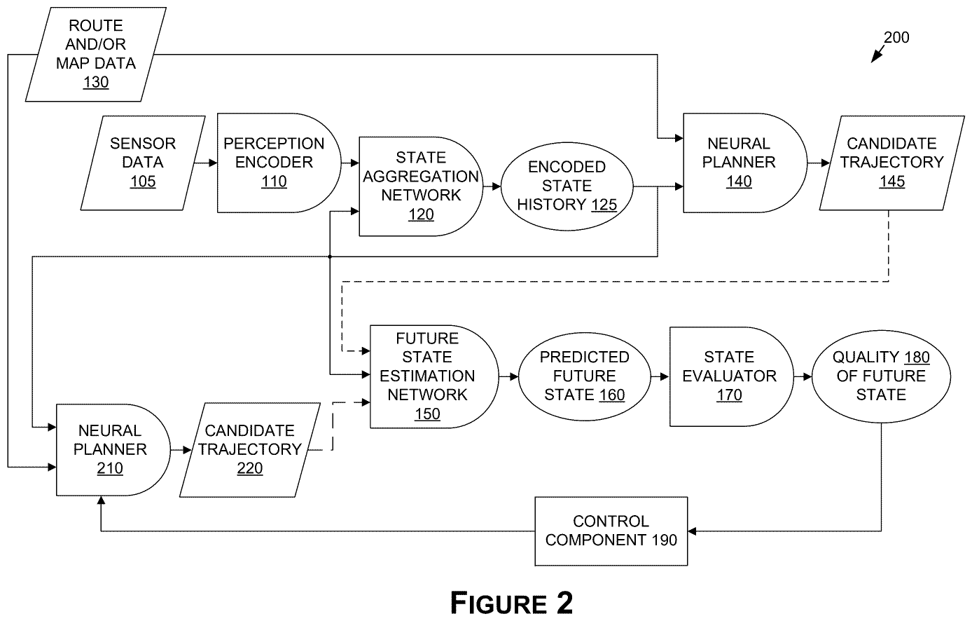

Turning now to FIG. 2, FIG. 2 is a data flow diagram illustrating an example control stack 200 that optimizes a trajectory to lead to a predicted favorable or beneficial future scene state, in accordance with some embodiments of the present disclosure. Although primarily described herein as a stack, control stack, or driving stack, this is not intended to be limiting, and the systems and methods described herein may alternatively be referred to as a processing pipeline, a process, a control stack, a driving stack, a software stack, a hardware/software stack, etc., without departing from the scope of the present disclosure.

The components of FIGS. 1 and 2 with the same reference numbers may operate similarly. However, in FIG. 2, if the control component 190 determines that the quality 180 (or favorability) of the predicted future state 160 does not satisfy a designated threshold, the control component 190 may initiate one or more iterations of a parameterized optimization to generate an optimized trajectory using the state evaluator 170 as the cost function. For example, the control component 190 may operate a parameterized planner (e.g., a neural planner 210), a parameterized optimization of the neural planner 210, future state estimation using the future sate estimation network 150, and state evaluation using the state evaluator 170 in a loop as an optimal planner, iteratively refining a trajectory predicted to lead to the most desirable (or optimized) state. As such, this loop may effectively operate as a secondary or alternate control stack when the candidate trajectory 145 and/or control actions generated using an existing or primary control stack fails to satisfy a designated threshold.

For example, in some embodiments (e.g., if the neural planner 210 and the neural planner 140 are instances of the same neural network), the control component 190 may optimize the neural planner 210 using the quality 180 (or favorability) of the predicted future state 160 (e.g., using gradients computed by back-propagating the quality 180 (or favorability) of the predicted future state 160 back to the neural planner 210), and the control component 190 may trigger a pass through the updated version of the neural planner 210, the future state estimation network 150, and the state evaluator 170. In some embodiments (e.g., if the neural planner 210 and the neural planner 140 are different networks), the control component 190 may trigger a pass through the neural planner 210, the future state estimation network 150, and the state evaluator 170 without an initial optimization of the neural planner 210.

In either scenario, the control component 190 may use the neural planner 210 to predict a candidate trajectory 220 and/or control actions. Generally, the neural planner 210 may be implemented using any type of machine learning model or neural network such as those described herein and may be used to predict or generate a candidate trajectory 220 and/or control actions from the encoded state history 125. For example, the neural planner 210 may predict any suitable representation of a candidate trajectory 220 (e.g., a sequence of future waypoints with associated timestamps, positions, velocities, and/or accelerations) and/or candidate control action(s) or actuation command(s) (e.g., steering angles, acceleration or throttle, brake pressures, high-level navigation decisions such as changing lanes, merging, or stopping at intersections). The neural planner 210 may accept inputs such as the encoded state history 125, the route and/or map data 130, an ego-state of the ego-machine, a history of actions taken by the ego-machine, and/or otherwise. As such, the neural planner 210 may use any known technique to generate a candidate trajectory 220 and/or control actions from those input(s).

As such, the control component 190 may use the neural planner 210 to predict a candidate trajectory 220 and/or control actions, may use the future state estimation network 150 to generate a predicted future state 160 that would result from the candidate trajectory 220 (e.g., replacing the candidate trajectory 145 from the first pass through the future state estimation network 150 with the candidate trajectory 220 for subsequent passes), and may use the state evaluator 170 to extract a measure of the quality 180 (or favorability) of the predicted future state 160. If the control component 190 determines that the quality 180 of the predicted future state 160 of the scene that would result from taking this optimized candidate trajectory 220 satisfies designated convergence criterion is satisfied (e.g., the candidate trajectory 220 and/or control actions are predicted to result in a predicted future state 160 with a quality 180 that satisfies the designated threshold), the control component 190 may use the optimized candidate trajectory 220 to control navigation. If not, the control component 190 may use any known optimization process to modify the parameters of the neural planner 210 to generate an improved candidate trajectory 220 using the state evaluator 170 as the cost function.

For example, the control component 190 may use any known technique (e.g., backpropagation) to compute the gradients of the quality 180 of the predicted future state 160 of the scene with respect to the parameters of the neural planner 210 and use the gradients to update the parameters of the neural planner 210, and the control component 190 may use the updated neural planner 210 to generate an improved modification to the candidate trajectory 220 and pass this improved candidate trajectory 220 to the future state estimation network 150 and state evaluator 170 for a subsequent evaluation. If the control component 190 determines that the quality 180 of the predicted future state 160 of the scene that would result from taking this optimized candidate trajectory 220 satisfies the designated threshold (e.g., the optimized candidate trajectory 220 is predicted to result in a favorable future state), the control component 190 may use the optimized candidate trajectory 220 to control navigation. If the control component 190 determines that the quality 180 of the predicted future state 160 of the scene does not satisfy the designated threshold, the control component 190 may iterate this optimization process in one or more additional passes of the loop, for example, until a designated convergence criterion is satisfied (e.g., until the optimized candidate trajectory 220 and/or control actions are predicted to result in a predicted future state 160 with a quality 180 that satisfies the designated threshold).

As such, the control component 190 may iteratively optimize the neural planner 210 and the resulting candidate trajectory 220 and/or control actions until identifying an optimized trajectory and/or control actions that lead to a predicted future state 160 with a quality 180 that satisfies the designated threshold. Accordingly, the control component 190 may use the optimized trajectory and/or control actions to control navigation of the ego-machine. In some embodiments, the control component 190 may use control actions predicted by the neural planner 210 (e.g., steering angles, acceleration or throttle, brake pressures, high-level navigation decisions such as changing lanes, merging, or stopping at intersections) as actuation commands. In some embodiments, the control component 190 may use a traditional controller to convert an optimized trajectory predicted by the neural planner 210 into corresponding control actions and may use those control actions as actuation commands. In some embodiments, to accommodate the additional time to run one or more iterations of the optimization loop, the control component 190 may adjust one or more driver assistance features such as adaptive cruise control (e.g., increase the following distance or reduce the vehicle's speed) to accommodate the longer processing time (much like humans slow down their vehicle when encountering an unknown situation).

As such, the control stack 200 may be deployed in an ego-machine and/or otherwise used to control navigation of the ego-machine. For example, the control stack 200 may run in real-time on a system-on-chip (which may correspond to the SoC(s) 404 of FIG. 4C) of an ego-machine (e.g., an automotive SoC such as NVIDIA's DRIVE Orin™ SoC, which may serve as a central computer for in-vehicle computing). Other types of SoCs which may be used in robots or ego-machines include AI-optimized SoCs (e.g., NVIDIA Jetson Series), robotics SoCs (e.g., for robotics applications such as drones, service robots, or industrial robots), industrial SoCs (e.g., for industrial robots or automation systems for factory automation, robotics, or control systems), drone and unmanned aerial vehicle (UAV) SoCs (e.g., for handling flight control, navigation, and/or real-time video processing), and/or others.

In some embodiments, the scenarios in which the neural planner 210 was engaged (e.g., scenarios in which the candidate trajectory 145 predicted by the neural planner 140 or other existing control stack did not satisfy the designated threshold) and/or scenarios in which the ego-machine was slowed down may be used to generate training data to improve the neural planner 210 or other existing planner or control stack. For example, if the candidate trajectory 145 predicted by the neural planner 140 results in a predicted future state 160 with a quality 180 that fails to meet a designated threshold, the vehicle (or other ego-machine) is likely in a situation it was not trained to handle, and it is likely to remain that way for some number of consecutive time slices (e.g., corresponding 10 Hertz or 100 millisecond decisions). As such, the control component 190 may record the optimized trajectories and/or control actions generated by the neural planner 210 and corresponding sensor data 105, include them in a training dataset, and use the training dataset (or some other training engine may use the training dataset) to train (e.g., fine-tune) the neural planner 140, the existing control stack, or some other planner or control stack. As such, the neural planner 140 and/or the end-to-end control stack should learn to generate better trajectories and actions over time, resulting in a more efficient control stack 200 (e.g., with less and less scenarios in which it slows down).

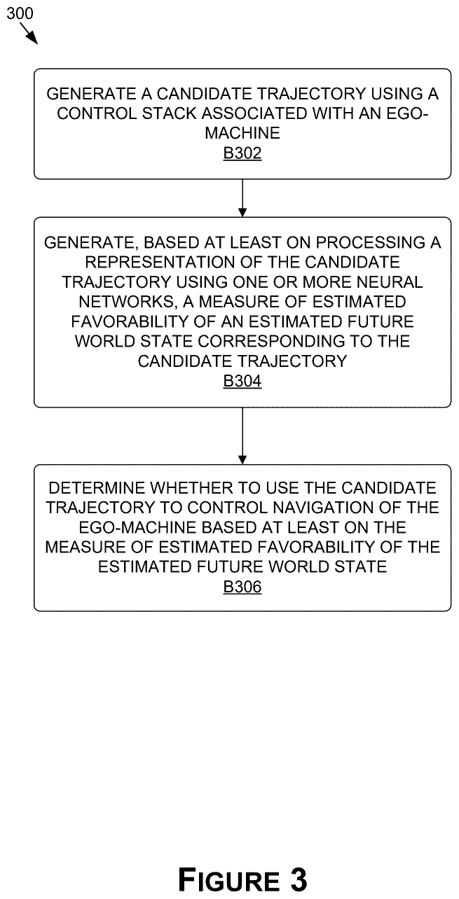

Now referring to FIG. 3, each block of method 300, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, method 300 is described, by way of example, with respect to FIGS. 1-2. However, this method may additionally or alternatively be executed by any one system, or any combination of systems, including, but not limited to, those described herein.

FIG. 3 is a flow diagram showing a method 300 for determining whether to use a candidate trajectory to control navigation of an ego-machine based at least on a measure of estimated favorability of an estimated future world state, in accordance with some embodiments of the present disclosure. The method 300, at block B302, may include generating a candidate trajectory using a control stack associated with an ego-machine. For example, an end-to-end control stack formed by the perception encoder 110, the state aggregation network 120, and the neural planner 140 of FIG. 1 or FIG. 2 may be used to generate the candidate trajectory 145 from the sensor data 105. In some embodiments, a classical planner may be used to generate the candidate trajectory.

The method 300, at block B304, may include generating, based at least on processing a representation of the candidate trajectory using one or more neural networks, a measure of estimated favorability of an estimated future world state corresponding to the candidate trajectory. For example, a (e.g., trajectory) evaluation network comprising the future state estimation network 150 and the state evaluator 170 of FIG. 1 or FIG. 2 may be used to predict and evaluate the quality, favorability, safety, acceptability, desirability, etc. of the state that would result from taking the candidate trajectory 145 and/or control actions predicted by the neural planner 140. In some embodiments, the upper branch of the control stack 100 and/or the control stack 200 may include a classical (e.g., rules-based, heuristic, etc.) planner that generates a candidate trajectory, and the lower branch may evaluate the candidate trajectory generated by the classical planner. In some embodiments, a classical or neural planner may generate a trajectory, a classical control algorithm may use the trajectory to generate optimized control actions, and the lower branch may evaluate the trajectory and/or optimized control actions.

The method 300, at block B306, may include determining whether to use the candidate trajectory to control navigation of the ego-machine based at least on the measure of estimated favorability of the estimated future world state. For example, the control component 190 of FIG. 1 or 2 may compare the quality 180 of the predicted future state 160 to a designated threshold, and if the quality 180 of the predicted future state 160 satisfies the designated threshold or thresholds (e.g., the candidate trajectory 145 is predicted to result in a favorable, safe, desirable, or beneficial future state), the control component 190 may use the candidate trajectory 145 and/or control actions to control navigation of the ego-machine.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 4A is an example of sensor locations having corresponding fields of view or sensory fields for an autonomous or semi-autonomous vehicle 400a, an autonomous mobile robot (AMR) 400b, and a humanoid robot 400c, in accordance with some embodiments of the present disclosure. Although three types of machines 400 are illustrated, this is not intended to be limiting, and the machine(s) 400 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 400a, AMR 400b, humanoid robot 400c, and/or other machine types may be referred to herein collectively as machine 400, in some instances.

With respect to vehicles 400A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J 3016-201609, published on Sep. 30, 2016, and previous and future versions of this standard). The machine 400 may be capable of functionality in accordance with one or more of Level 3-Level 5 of the autonomous driving levels. The machine 400 may be capable of functionality in accordance with one or more of Level 1-Level 5 of the autonomous driving levels. For example, the machine 400 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 400 or other machine, such as being fully autonomous, being highly autonomous, being conditionally autonomous, being partially autonomous, providing assistive autonomy, being semi-autonomous, being primarily autonomous, or other designation.

With respect to FIG. 4A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 468D, a 180 degree field of view of a wide-view camera 470, a 360 degree sensory field of a LiDAR sensor 464, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 400a, AMR 400b, and/or humanoid robot 400c, etc. For example, with respect to the vehicle 400a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 400b and/or humanoid robot 400c, the shape, size, purpose, implementation, model, etc. may dictate the number and types of sensors used.

As illustrated in FIG. 1A, the autonomous or semi-autonomous vehicle 400A, the AMR 400B, and the humanoid robot 400C may include different sensor types, number, and locations. For a non-limiting example, the vehicle 400A may include twelve cameras 464, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 464 may use, in embodiments, a gigabit multimedia serial link (GMSL) interface—such as GMSL2—as input/output (I/O).

In some embodiments, although not illustrated in FIG. 4A, the vehicle 400A may include an in-cabin occupant and/or driver monitoring system, that may include various different sensors. For example, the in-cabin sensors may include various cameras 468, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 468, the internal camera(s) 468 may, in embodiments, use a GMSL (such as GMSL2) interface for I/O.

As another non-limiting example, the vehicle 400A may further include nine RADAR sensors 460. For example, the vehicle 400A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 460 may use, in embodiments, an Ethernet interface as I/O.

The vehicle(s) 400A may further include, as a non-limiting example, twelve ultrasonic sensors 462. As illustrated in FIG. 4A, the ultrasonic sensors may be positioned along the front and rear bumpers of the vehicle 400A, and along the side of the vehicle 400A, and may be used to detect objects (static and dynamic) in close proximity to the vehicle 400A. In some embodiments, the ultrasonic sensor(s) 462 may use a DS13 interface as I/O.

The vehicle(s) 400A may further include, as a non-limiting example, a LiDAR sensor 464, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 464 may include a 360 degree horizontal FOV or sensory field (such as in a spinning LiDAR sensor) and a 90 degree vertical FOV or sensory field. In some embodiment, the LiDAR sensor(s) 464 may use an Ethernet interface as I/O.

The autonomous mobile robot (AMR) 400B may include, as a non-limiting example, three LiDAR sensors 464. For example, the top-most illustrated LiDAR sensor 464 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 400B may further include, as a non-limiting embodiment, eight cameras 468, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 400B may further include a charging port, charging port contacts, a status indicator light, one or more (e.g., four) RGB LEDs, one or more IMU sensors 466, a magnetometer, and a barometer. The AMR 400B is capable of high-precision time synchronization between sensors using hardware time stamping, and PTP over Ethernet with less than 10 microseconds for sensor acquisition time. The AMR 400B provides simultaneous camera capture across all cameras 468 within 100 microseconds from a single hardware trigger, in embodiments, and can write to disk at 4 GB/second for sensor capture to bag writing (e.g., writing to ROSbags for the robot operation system (ROS)). As such, the AMR 400B is capable of running the ROS (such as NVIDIA's Isaac ROS), can be teleoperated (as described herein), can map an environment, and can navigate within an environment using visual cameras 468, LiDARs 464, and/or other sensor types or modalities.

The humanoid robot 400C may include, as a non-limiting example, one LiDAR sensor 464. For example, the LiDAR sensor 464 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 400C may further include, as a non-limiting embodiment, four cameras 468, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 400C may further include, as a non-limiting embodiment, four ultrasonic sensors 462, such as a left arm ultrasonic sensor, a right arm ultrasonic sensor, a left leg ultrasonic sensor, and right leg ultrasonic sensor.

The humanoid robot 400C may further include any number of actuators—such as to allow control and maneuverability of joints. For example, the humanoid robot 400C may include actuators that allow for various degrees of freedom (DoF) depending on the design. In a non-limiting embodiment, the humanoid robot 400C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 400C may include position and orientation sensors, such as encoders, gyroscopes, and the like, to determine the position of the robot 400C in space, allowing for location determination and movement tracking. The humanoid robot 400C may include force and pressure sensors, in embodiments, to detect environment interactions, allowing the robot 400C to grasp objects with the right force and to avoid obstacles along the way. The perception sensors (e.g., cameras, LiDARs, RADARs, ultrasonic, SONAR, etc.) may be used along with tactile sensors to allow the robot 400C to perceive objects, shapes, and textures, and to understand when touch is initiated and stopped (along with force sensors that regulate the force used during touch). As a non-limiting example, the humanoid robot 400C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 400C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 400C may use onboard sensors, microphones, and speakers to understanding speech, audio and visual cues, etc., while also being able to communicate back to the environment.

With reference to cameras 468 of the machine(s) 400, the camera types for the cameras 468 may include, but are not limited to, digital cameras that may be adapted for use with the components and/or systems of the machine 400. For a vehicle 400a implementation, the camera(s) 468 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 468B that may be used to perceive objects coming into view from the periphery (e.g., pedestrians, warehouse vehicles, other robots, crossing traffic, or bicycles). In addition, any number of long-range camera(s) 468E (e.g., a long-view stereo camera pair) may be used for depth-based object detection, especially for objects for which a neural network has not yet been trained. The long-range camera(s) 468E may also be used for object detection and classification, as well as basic object tracking.

Any number of stereo cameras 468A may also be included in a front-facing and/or other (e.g., rear-facing) configuration. In at least one embodiment, one or more of stereo camera(s) 468A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 400 environment, including a distance estimate for points in the image (e.g., a disparity or depth image). An alternative stereo camera(s) 468A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 400 (e.g., side-view cameras) may be used, for example, for surround view, providing information used to create and update the occupancy grid, as well as to generate side impact collision warnings and/or to indicate to an AMR 400B or humanoid robot 400C, for example, that there are objects, features, and/or persons present to the side. For example, surround camera(s) 468D may be positioned on the machine 400. The surround camera(s) 468D may include wide-view camera(s) 468B, fisheye camera(s), 360 degree camera(s), and/or the like. For example, four fisheye cameras may be positioned on the machine's 400 front, rear, and sides. In an alternative arrangement, the machine 400 may use three surround camera(s) 468D (e.g., left, right, and rear), and may leverage one or more other camera(s) (e.g., a forward-facing camera) as a fourth surround view camera.

Cameras 468 with a field of view that include portions of the environment to the rear of the machine 400 (e.g., rear-view cameras) may be used for gaining an understanding of objects, features, persons, and/or other information to the rear of the machine 400, such as for park assistance, surround view, rear collision warnings, planning, control, and navigation determinations, and/or creating and updating an occupancy grid, BEV image representing the environment, height map, etc. A wide variety of cameras 468 may be used including, but not limited to, cameras 468 that are also suitable as a front-facing camera(s) (e.g., long-range and/or mid-range camera(s) 468E, stereo camera(s) 468A), infrared camera(s) 468C, etc.), rear-facing camera(s), side-facing camera(s), downward facing camera(s), upward facing camera(s), and/or the like, as described herein.

Similarly, for LiDAR sensors 464, RADAR sensors 460, ultrasonic sensors 462, and/or other sensor modalities or types, the location and placement of the sensors, and their corresponding fields of view or sensory fields may be determined based on the use case, implementation, or design of the particular machine 400.

For example, the machine(s) 400 include RADAR sensor(s) 460 that may be used by the machine 400 for long-range object detection, even in darkness and/or severe weather conditions. RADAR functional safety levels may be ASIL B, in embodiments. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250m range. The RADAR sensor(s) 460 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 400 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 460 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 400 (e.g., vehicle, robot, etc.). As such, short-range RADAR systems may be used in an ADAS system for blind spot detection and/or lane change assist.

The machine 400 may further include ultrasonic sensor(s) 462. The ultrasonic sensor(s) 462, which may be positioned at the front, back, and/or the sides of the machine 400, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 400. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B, as an example.

The machine 400 may include LiDAR sensor(s) 464. The LiDAR sensor(s) 464 may be used for object and feature detection, pedestrian and other robot detection, emergency braking, collision avoidance, simultaneous localization and mapping (SLAM), free-space detection, and/or other functions. The LiDAR sensor(s) 464 may be functional safety level ASIL B, in embodiments. In some examples, the machine 400 may include multiple LiDAR sensors 464 (e.g., two, four, six, etc.) that may use Ethernet (e.g., to provide data to a Gigabit Ethernet switch).

In some examples, the LiDAR sensor(s) 464 may be capable of providing a list of objects and their distances for a 360-degree field of view. Commercially available LiDAR sensor(s) 464 may have an advertised range of approximately 400 m, with an accuracy of 2 cm-3 cm, and with support for a 400 Mbps Ethernet connection, for example. In some examples, one or more non-protruding LiDAR sensors 464 may be used. In such examples, the LiDAR sensor(s) 464 may be implemented as a small device that may be embedded into the front, rear, sides, top, and/or corners of the machine 400. The LiDAR sensor(s) 464, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 400. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 464 may be less susceptible to motion blur, vibration, and/or shock.

FIG. 4B is an illustration of sensor and component locations of an example autonomous or semi-autonomous vehicle 400A (alternatively referred to herein as “vehicle 400,” “ego-vehicle 400,” “ego-machine 400,” or “machine 400,”), in accordance with some embodiments of the present disclosure. Although the vehicle 400A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 4C is a block diagram of an example system architecture for a machine 400, such as autonomous or semi-autonomous vehicle 400A, autonomous mobile robot (AMR) 400B, humanoid robot 400C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 400 of FIGS. 4A-4E, example computing ecosystem 500 of FIG. 5, example generative language model system 600 of FIG. 6, and/or example computing device 700 of FIG. 7.

Each of the components, features, and systems of the machine 400 in FIG. 4C are illustrated as being connected via bus 402 (alternatively referred to as a “machine communications network 402,” or just “communications network 402”). The bus 402 may include a Controller Area Network (CAN) data interface (alternatively referred to herein as a “CAN bus”). A CAN may be a network inside the machine 400 used to aid in control of various features and functionality of the machine 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 402 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the machine 400, and two or more busses 402 may communicate with the same components. In some examples, each SoC 404, each controller 436, and/or each computer or compute engine within the machine 400 may have access to the same input data (e.g., inputs from sensors of the machine 400), and may be connected to a common bus, such as a CAN bus.

The machine 400 may include components such as a chassis, a vehicle body, wheels (e.g., 2, 4, 6, 8, 18, etc.), tires, axles, batteries, side-view mirrors, and/or other components of a vehicle or machine. The machine 400 may include a propulsion system 450, such as an internal combustion engine, hybrid electric power plant, an all-electric engine, a hydrogen-fueled engine, and/or another propulsion system type. The propulsion system 450 may be connected to a drive train of the machine 400, which may include a transmission, to enable the propulsion of the machine 400. The propulsion system 450 may be controlled in response to receiving signals from the throttle/accelerator 452.

A steering system 454, which may include a steering wheel and/or other steering device (e.g., remote steering and/or local steering), may be used to steer the machine 400 (e.g., along a desired path or route) when the propulsion system 450 is operating (e.g., when the vehicle is in motion). The steering system 454 may receive signals from a steering actuator 456. In some embodiments, a steering wheel or other steering mechanism may not be included, such as for a machine 400 capable of full automation (e.g., Level 5) functionality.

The brake sensor system 446 may be used to operate the vehicle brakes in response to receiving signals from the brake actuators 448 and/or brake sensors.

The machine 400 may include one or more controller(s) 436, such as those described herein with respect to FIG. 4A. The controller(s) 436 may be used for a variety of functions, and may be coupled to any of the various other components and systems of the machine 400. For example, the controllers 436 may be used for control of the machine 400, artificial intelligence executing on the machine 400, infotainment for the machine 400, and/or the like. For example, one controller 436 may be used for some or all of the functionality, or different controllers 436 may be used for different functionalities—e.g., to ensure availability and a safety separation between various controllers for different tasks. For example, the controller(s) 436 may use plans computed by the system—e.g., paths or trajectories for vehicles 400A or AMRs 400B, or movements, components trajectories, movement locations or displacements, etc. for joints or components (e.g., of manipulators, end effectors, limbs, hands, fingers, legs, feet, etc.), of a humanoid robot 400C—to control the machine(s) 400 in the environment. In some instances, the controller(s) 436 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 400C, for example, the controller(s) 436 may act as the brain, responsible for analyzing sensor data, making decisions, and sending commands to the actuators. The controller(s) 436 may include a low-level controller that handles basic motor control, ensuring accurate and precise movements of individual joints and actuators. The controller(s) 436 may include a high-level controller to coordinate multiple actuators and sensors, planning complex motions and adapting to changing environments.

The controller(s) 436 may include an artificial intelligence controller, in embodiments, that may use AI algorithms (e.g., DNNs, MLMs, etc.) to learn, make decisions, and autonomously perform tasks for the machine 400. In some embodiments, the controller(s) 436 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 436 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 436, which may include one or more systems on chip (SoCs) 404 (FIGS. 4C and 4D), CPUs, GPU(s), accelerator(s), etc., may provide signals (e.g., representative of commands or messages) to one or more components and/or systems of the machine 400. Although the controller(s) 436 is listed separately from the SoC(s) 404, this is not intended to be limiting, and in some embodiments one or more components of the SoC(s) 404 may perform the operations of the controller(s) 436. For example, the controller(s) may send signals to operate the machine brakes via one or more brake actuators 448, to operate the steering system 454 via one or more steering actuators 456, to operate the propulsion system 450 via one or more throttle/accelerators 452, etc. The controller(s) 436 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 400. The controller(s) 436 may include a first controller 436 for autonomous control and navigation functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 436 may handle two or more of the above functionalities, two or more controllers 436 may handle a single functionality, and/or any combination thereof.

The controller(s) 436 may provide the signals for controlling one or more components and/or systems of the machine 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LiDAR sensor(s) 464, inertial measurement unit (IMU) sensor(s) 466 (e.g., accelerometer(s), gyroscope(s), magnetic compass(es), magnetometer(s), etc.), microphone(s) 496, camera(s) 468 (e.g., stereo camera(s) 468A, wide-view camera(s) 468B (e.g., fisheye cameras), infrared camera(s) 468C, surround camera(s) 468D (e.g., 360 degree cameras), long-range and/or mid-range camera(s) 468E, and/or other camera types), speed sensor(s) 444 (e.g., for measuring the speed of the machine 400), vibration sensor(s) 442, steering sensor(s) 440, brake sensor(s) (e.g., as part of the brake sensor system 446), actuators, and/or other sensor types.

One or more of the controller(s) 436 may receive inputs (e.g., represented by input data) from an instrument cluster 432 of the machine 400 and provide outputs (e.g., represented by output data, display data, etc.) via a human-machine interface (HMI) display 434 (e.g., screen, heads-up display, mirror display, facial display, robotic display, etc.), an audible annunciator, a loudspeaker, a speaker, and/or via other components of the machine 400. The outputs may include information such as machine velocity, speed, time, map data corresponding to a map(s) 422 of FIG. 4C (e.g., from a navigation map, a Standard Definition (SD) map, a High Definition (“HD”) map, etc.), location data (e.g., the machine's 400 location, such as on a map 422), direction, location of other vehicles (e.g., an occupancy map, height map, bird's eye view (BEV) image, grid, etc.), information about objects and status of objects as perceived by the system, system status information, etc. For example, the HMI display(s) 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 400 may include one or more systems on a chip (SoCs) 404 (described in more detail in FIG. 4D). The SoC(s) 404 may include CPU(s) 406, GPU(s) 408, processor(s) 410, cache(s) 412, accelerator(s) 414, data store(s) 416, and/or other components and features. The SoC(s) 404 may be used to process and provide data for various operations, such as navigation, planning, reasoning, inference, perception, control, and/or actuation operations of the machine 400 in a variety of platforms and systems. For example, the SoC(s) 404 may process live perception data (e.g., from camera, LiDAR, RADAR, ultrasonic, etc.) in addition to map data corresponding to one or more maps 422 (e.g., HD map, SD map, navigational map, occupancy map, etc.) in order to make or aid in performing various operations of the machine 400. Where a map and/or AI is used, map and/or AI (e.g., model parameter updates, fine-tuning, etc.) refreshes and/or updates via a network interface 424 from one or more servers (e.g., server(s) 478 of FIG. 4E)—such as one or more servers of a cloud-based data center.

Although an SoC(s) 404 is illustrated throughout FIGS. 4A-4E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 400, use of the machine 400, model of the machine 400, and required capabilities of the machine 400, one or more SoCs 404 and/or alternative architectures and/or components may be used to satisfy the particular implementation.

The machine 400 may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The machine 400 may include a GPU(s) 420 (e.g., discrete GPU(s), or dGPU(s)), that may be coupled to the SoC(s) 404 via a high-speed interconnect (e.g., NVIDIA's NVLink). The GPU(s) 420 may provide additional artificial intelligence functionality, such as by executing redundant and/or different neural networks, and may be used to train and/or update neural networks based on input (e.g., sensor data) from sensors of the machine 400.

The machine 400 may further include the network interface 424 which may include one or more wireless antennas 426 and/or modems (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 400 information about vehicles in proximity to the machine 400 (e.g., vehicles in front of, on the side of, and/or behind the machine 400). This functionality may be part of a cooperative adaptive cruise control functionality of the machine 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The machine 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The machine 400 may further include IMU sensor(s) 466. The IMU sensor(s) 466 may be located at a center of the rear axle of the machine 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the machine 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include one or more microphone 496 placed in and/or around the machine 400. The microphone(s) 496 may be used for emergency vehicle detection and identification, among other things.

The machine 400 may further include vibration sensor(s) 442. The vibration sensor(s) 442 may measure vibrations of components of the machine, such as the arms or legs of a humanoid robot 400C, or the axle(s) of a vehicle 400A or AMR 400B. For example, changes in vibrations may indicate a change in road, walking, or traversable surfaces. In another example, when two or more vibration sensors 442 are used, the differences between the vibrations may be used to determine friction or slippage of the surface (e.g., when the difference in vibration is between a power-driven axle and a freely rotating axle).

The machine 400 may include an ADAS system 438—such as when the machine 400 is a vehicle 400A. The ADAS system 438 may include a dedicated SoC(s), in some examples. The ADAS system 438 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 400 may further include the infotainment SoC 430 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 400. For example, the infotainment SoC 430 may radios, disk players, navigation systems, video players, USB and Bluetooth connectivity, carputers, in-vehicle entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the machine 400. In some examples, the infotainment SoC 430 may be coupled to a supervisory MCU such that the GPU of the infotainment system may perform some self-driving functions in the event that the primary controller(s) 436 (e.g., the primary and/or backup computers of the machine 400) fail. In such an example, the infotainment SoC 430 may put the machine 400 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 400—whether a vehicle 400A, AMR 400B, humanoid robot 400C, and/or other type of machine—may include a locally stored language model(s) and/or communicate to a remotely hosted language model (e.g., via one or more APIs) to provide more detailed and in-depth communication features to the users of the machine(s) 400.

In some examples, an infotainment SoC 430, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or vehicle jacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 400.

The machine 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a block diagram of an example architecture of a computing system (a subset of the system described with respect to FIG. 4C), in accordance with at least some embodiments of the present disclosure. Although illustrated as an SoC(s) 404, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 404 may be an end-to-end platform with a flexible architecture that spans automation levels 2-5, or the SoC(s) 404 may be specifically designed for a specific automation level (e.g., a first SoC 404 for level 2 to level 2++, a second SoC 404 for level 3, a third SoC 404 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 2-5 autonomous vehicles as well as for safe planning, navigation, and control of AMRs 400B, humanoid robots 400C, and/or other robot or machine types.

In some embodiments, such as where the SoC(s) 404 include a GPU 408 with 2000 or more cores (e.g., 2048 cores), 60 or more tensor cores (e.g., 64 tensor cores), and a GPU max frequency of over 1 GHz (e.g., 1.3 GHz), a CPU 406 including 10 or more cores (e.g., 12 cores), with 64 bits, 3 MB L2 and 6 MB L 3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 409 (e.g., 2 DLAs/XNNs/NNAs/NPUs 409), and a vision accelerator—such as a programmable vision accelerator (PVA) 407, a single SoC 404) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 404 include a GPU 408 with 1700 or more cores (e.g., 1792 cores), 50 or more tensor cores (e.g., 56 tensor cores), and a GPU max frequency of over 900 MHz (e.g., 930 MHz), a CPU 406 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 409 (e.g., 2 DLAs/XNNs/NNAs/NPUs 409), and a vision accelerator—such as a programmable vision accelerator (PVA) 407, a single SoC 404) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 404 include a GPU 408 with 1000 or more cores (e.g., 1024 cores), 28 or more tensor cores (e.g., 32 tensor cores), and a GPU max frequency of over 900 MHz (e.g., 1173 MHz), a CPU 406 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 409 (e.g., 1 DLA/XNN/NNA/NPU 409), and a vision accelerator—such as a programmable vision accelerator (PVA) 407, a single SoC 404) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 404 include a GPU 408 with 1000 or more cores (e.g., 1024 cores), 28 or more tensor cores (e.g., 32 tensor cores), and a GPU max frequency of over 900 MHz (e.g., 1020 MHz), a CPU 406 including 6 or more cores (e.g., 6 cores), with 64 bits, 1.5 MB L2 and 4 MB L3 cache memory, and a max frequency of 1.5 or more GHz (e.g., 1.7 GHz), a single SoC 404) may be capable of 67 tera operations per second (TOPS) of AI performance. For example, NVIDIA's Jetson Orin Nano 8 GB SoC satisfies these criteria, and achieves this performance.

The SoC(s) 404 may include one or more CPUs 406. The CPU(s) 406 may include a CPU cluster or CPU complex (alternatively referred to herein as a “CCPLEX”), in embodiments. The CPU(s) 406 may include multiple cores and/or (e.g., L2, L3) caches. For example, in some embodiments, the CPU(s) 406 may include twelve cores in a coherent multi-processor configuration. In some embodiments, the CPU(s) 406 may include four dual-core clusters where each cluster has a dedicated L2 cache (e.g., a 3 MB L2 cache). The CPU(s) 406 (e.g., the CCPLEX) may be configured to support simultaneous cluster operation enabling any combination of the clusters of the CPU(s) 406 to be active at any given time.

The SoC(s) 404 may include any type and number of GPUs 408. For example, an integrated GPU(s) (alternatively referred to herein as an “iGPU(s)”) may be used in some embodiments. The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive, robotics, and/or other embedded use cases. For example, the GPU(s) 408 may be fabricated on a Fin field-effect transistor (FinFET). However, this is not intended to be limiting and the GPU(s) 408 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP 32 cores, 8 FP64 cores, 16 INT 32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

The SoC(s) 404 may include any number of cache(s) 412, including those described herein. For example, the cache(s) 412 may include L0 caches, L1 caches, L2 caches, L3 caches (e.g., that are available to both the CPU(s) 406 and the GPU(s) 408 (e.g., that is connected both the CPU(s) 406 and the GPU(s) 408)), etc. The cache(s) 412 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 404 may include one or more arithmetic logic units (ALUs) 465 which may be leveraged in performing processing with respect to any of the variety of tasks or operations of the machine 400—such as computer vision, machine learning or deep learning processing, world model management, etc. In addition, the SoC(s) 404 may include a floating point unit(s) (FPU(s)) 467—or other math coprocessor or numeric coprocessor types—for performing mathematical operations within the system. For example, the SoC(s) 104 may include one or more FPUs 467 integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory 415 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 414 (e.g., the hardware acceleration cluster) may include a deep learning accelerator(s) (DLA) 409 (alternatively referred to herein as “a deep learning accelerator cluster (XNN) 409,” “neural network accelerator (NNA) 409,” or “neural processing unit (NPU) 409”). The DLA(s) 409 may include one or more Tensor processing units (TPUs) 441 that may be configured to provide an additional, e.g., ten trillion operations per second for deep learning applications and inferencing. The TPUs 441 may be accelerators configured to, and optimized for, performing image processing functions (e.g., for CNNs, RCNNs, DNNs, etc.). The DLA(s) 409 may further be optimized for a specific set of neural network types and floating point operations, as well as inferencing. The design of the DLA(s) may provide more performance per millimeter than a general-purpose GPU, and vastly exceeds the performance of a CPU. The TPU(s) 441 may perform several functions, including a single-instance convolution function, supporting, for example, INT8, INT16, and FP16 data types for both features and weights, as well as post-processor functions. Although the TPU(s) 441 are described as being included as part of the DLA(s) 409, this is not intended to be limiting, and the TPU(s) 441 may be included in additional or alternative accelerator(s) 414 and/or other components, and/or may be included as a discrete processing component(s).

The DLA(s) 409 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 409 may perform any function of the GPU(s) 408, and by using an inference accelerator, for example, a designer may target either the DLA(s) 409 or the GPU(s) 408 for any function. For example, the designer may focus processing of DNNs and floating point operations on the DLA(s) 409 and leave other functions to the GPU(s) 408 and/or other accelerator(s) 414. The DLA(s) 409 may be used to run any type of network to enhance control and safety, including for example, a neural network that outputs a measure of confidence for each object detection.

The accelerator(s) 414 (e.g., the hardware acceleration cluster) may include a programmable vision accelerator(s) (PVA) 407, which may alternatively be referred to herein as a computer vision accelerator or generally a vision accelerator. The PVA(s) 407 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 407 may provide a balance between performance and flexibility. For example, each PVA(s) 407 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 407 may be optimized for the tasks of image processing and computer vision algorithm acceleration. For example, the PVA(s) 407 provides excellent performance with extremely low power consumption, and can be used asynchronously and concurrently with the CPU(s) 406, GPU(s) 408, and/or other accelerators in the system (e.g., vehicle, robot, etc.) as part of a heterogeneous compute pipeline.

The PVA(s) 407 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 443 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 406 (e.g., ARM Cortex-R5 processor), facilitating data exchange with the CPU(s) 406 and other system-level components. The VPU I-cache may supply instruction data to the VPU(s) when requested, may request missing instruction data from system memory, and/or may maintain temporary instruction storage for the VPU. For each VPU task, the CPU(s) 406 may configures the DMA system, optionally prefetch the VPU program into VPU I-cache, and/or kick off each VPU-DMA pair to process a task. The PVA(s) 407 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 407 to access the system memory independently of the CPU(s) 406. The DMA may support any number of features used to provide optimization to the PVA(s) 407 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 407 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 407, and may include one or more vector processing units (VPUs), one or more pixel processing engines (PPEs) west—which may include a 2D layout of interconnected (e.g., for north, south, east, intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 407 may be configured to employ data parallelism. For example, in some embodiments, the plurality of vector processors included in a single PVA(s) 407 may execute the same computer vision algorithm, but on different regions of an image. In other examples, the vector processors included in a particular PVA(s) 407 may simultaneously execute different computer vision algorithms, on the same image, or even execute different algorithms on sequential images or portions of an image. Among other things, any number of PVAs 407 may be included in the hardware acceleration cluster and any number of vector processors may be included in each of the PVAs. In addition, the PVA(s) 407 may include additional error correcting code (ECC) memory, to enhance overall system safety.

The accelerator(s) 414 (e.g., the hardware accelerator cluster) have a wide array of uses for autonomous and semi-autonomous machine control. The PVA(s) 407 may be a programmable vision accelerator that may be used for key processing stages in perception, robotics understanding and reasoning, ADAS, semi-autonomous, and autonomous vehicles, etc. The PVA's 407 capabilities are a good match for algorithmic domains needing predictable processing, at low power and low latency. In other words, the PVA(s) 407 performs well on semi-dense or dense regular computation, even on small data sets, which need predictable run-times with low latency and low power. Thus, in the context of platforms for autonomous vehicles and robotics, the PVAs 407 are designed to run classic computer vision algorithms, as they are efficient at object detection and operating on integer math.

For example, according to one embodiment of the technology, the PVA 407 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 407 may perform computer stereo vision function on inputs from two monocular cameras.

In some examples, the PVA(s) 407 may be used to perform dense optical flow. According to process raw RADAR data (e.g., using a 4D Fast Fourier Transform) to provide Processed RADAR. In other examples, the PVA(s) 407 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 407, this is not intended to be limiting. In some embodiments, these components may be included in alternative or additional processing components and/or accelerator(s) 414, and/or may be included as discrete components of the SoC(s) 404 and/or other computing system architecture(s).

In some examples, the SoC(s) 404 may include a real-time ray-tracing hardware accelerator (RTA) 451 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 400 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 451 and/or a ray-tracing optimized GPU 406—such as NVIDIA's RTX GPU.

The accelerator(s) 414 (e.g., in the hardware acceleration cluster) may include one or more optical flow accelerators (OFAs) 411. For example, the OFA(s) 411 may be used for computing optical flow and stereo disparity between frames of sensor data (e.g., images). Optical flow may be accelerated on the OFA(s) 411 for uses such as object detection and tracking, and/or for stereo depth estimation where used for computing stereo disparity between stereo image frames (e.g., two or more frames captured using two or more image sensors with at least partially overlapping fields of view).

The SoC(s) 404 may include one or more camera serial interfaces (CSIs) 423. For example, the CSI(s) 423 may include a mobile industry processor interface (MIPI) camera serial interface (CSI) for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role. For example, the CSI 423 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2x MIPI CSI-2, 22 pin camera connector, depending on the embodiment and implementation.

The accelerator(s) 414 (e.g., the hardware acceleration cluster) may include a computer vision network on-chip (CVNOC) 463 and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by the PVA 407, OFA 411, DLA 409, and/or other accelerator(s) 414. Each pair of memory blocks may include an advanced peripheral bus (APB) interface, configuration circuitry, a controller, and a multiplexer. Any type of memory 415 may be used. The PVA 407, OFA 411, DLA 409, and/or other accelerator(s) 414 may access the memory via a backbone that provides the accelerator(s) 414 with high-speed access to memory. The backbone may include a computer vision network on-chip that interconnects the accelerator(s) 414 to the memory (e.g., using the APB).

The CVNOC 463 may include an interface that determines, before transmission of any control signal/address/data, that the accelerator(s) 414 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 404 may include data store(s) 416 and/or memory 415. The data store(s) 416 may be on-chip memory 415 of the SoC(s) 404, which may store neural networks and/or other algorithms to be executed on the CPU(s) 406, the GPU(s) 408, and/or one or more of the accelerator(s) 414. In some examples, the data store(s) 416 may be large enough in capacity to store multiple instances of neural networks for redundancy and safety. The data store(s) 412 may comprise L2 and/or L3 cache(s) 412, for example. The memory(ies) 415 may include SRAM, LPDDR5, and/or other memory types. For example, the memory(ies) 415 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 416 may include reference to the memory associated with the PVA 407, OFA 411, DLA 409, and/or other accelerator(s) 414, as described herein.

The data store(s) 116 may include various storage types, such as eMMC, NVMe, etc. For example, the SoC(s) 404 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 416 and/or other storage may be accessed via, e.g., NVMe, using PCI Express (PCIe), RDMA, TCP, and/or other protocols.

The SoC(s) 404 may include one or more processor(s) 410 (e.g., embedded processors). The processor(s) 410 may include a boot and power management processor (BPMP) 453, that may be a dedicated processor and subsystem to handle boot power and management functions and related security enforcement. The BPMP 453 may be a part of the SoC(s) 404 boot sequence and may provide runtime power management services. The BPMP 453 may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, accelerator(s) 414, and/or other components. If temperatures are determined to exceed a threshold, BPMP 453 may enter a temperature fault routine and put the SoC(s) 404 into a lower power state and/or put the machine 400 into a chauffeur to safe stop mode (e.g., bring the machine 400 to a safe stop).

The processor(s) 410 may further include a set of embedded processors that may serve as an audio processing engine (APE) 455. The APE 455 may be an audio subsystem that enables full hardware support for multi-channel audio over multiple interfaces, and a broad and flexible range of audio I/O interfaces. In some examples, the APE 455 is a dedicated processor core with a digital signal processor with dedicated RAM.

The processor(s) 410 may further include an always on processor engine (AOPE) 457 that may provide necessary hardware features to support low power sensor management and wake use cases. The AOPE 457 may include a processor core, a tightly coupled RAM, supporting peripherals (e.g., timers and interrupt controllers), various I/O controller peripherals, and routing logic.

The processor(s) 410 may further include a safety processor(s) 413 (alternatively referred to as “safety island 413”), which may include a safety cluster engine that includes a dedicated processor or processor subsystem to handle safety management for automotive, robotics, and/or other applications. The safety processor(s) 413—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 413 may include a discrete processor(s), such that fault of other system components may not impact the performance and availability of the safety processor 413.

The processor(s) 410 may further include a real-time or near real-time sensor engine (SE) 459 that may include a dedicated processor subsystem for handling real-time or near real-time camera, LiDAR, RADAR, and/or other sensor modality management.

The processor(s) 410 may further include one or more image signal processors (ISPs) 427, which may include a high-dynamic range signal processor and/or a hardware engine that is part of one or more sensor processing pipelines.

The processor(s) 410 may include a video image compositor (VIC) 461 that may be a processing block (e.g., implemented on a microprocessor) that implements video post-processing functions needed by a video playback application to produce the final image for the player window. The VIC 461 may perform lens distortion correction on wide-view camera(s) 468B, surround camera(s) 468D, in-cabin monitoring camera sensors, and/or other camera sensors with distorted fields of view.

A VIC 461 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 461 may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a broad range of peripheral interfaces for input/output (I/O) 425, such as to enable communication with peripherals, audio codecs, power management, and/or other devices. The SoC(s) 404 may be used to process data from cameras (e.g., connected over Gigabit Multimedia Serial Link and/or Ethernet), sensors (e.g., LiDAR sensor(s) 464, RADAR sensor(s) 460, etc. that may be connected over Ethernet), data from bus 402 (e.g., speed of machine 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks. In some embodiments, the SoC(s) 404 I/O 425 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 425 elements, components, or features.

The SoC(s) 404 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 404 may include an RJ45 connector with up to 10 GbE, a 1 GbE connector, and/or other networking connector types.

The SoC(s) 104 may include one or more digital signal processors (DSPs) 443. For example, the DSP(s) 443 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 404 may include one or more video encoders 419 and/or one or more video decoders 421. For example, the video encoder(s) 419 may include a hardware-based (e.g., as part of the GPU(s) 408) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 421 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 421 may be hardware-based (e.g., as part of the GPU(s) 408).

The SoC(s) 404 may include one or more general compute acceleration clusters (GCAC(s)) 429. For example, the GCAC(s) 429 may include various processor types that may be used to accelerate compute, such as one or more vector microcode processors (VMPs) 433, one or more multi-threaded processing clusters (MPCs) 431, one or more programmable macro arrays (PMA(s)) 435, and/or one or more other processor types. For example, the GCAC(s) 429 may include a PMA 435, two VMPs 433, and 2 MPCs 431.

The SoC(s) 404 may include one or more vector microcode processors (VMPs) 433. The VMP(s) 433, in embodiments, may include a wide vector (very long instruction word (VLIW) and single instruction multiple data (SIMD)) machine with performing various operations, such as short integral type operations common in computer vision and deep learning algorithms.

The SoC(s) 404 may include one or more multi-threaded processing clusters (MPCs) 431. The MPC(s) 431 may include a processing cluster that be, in embodiments, more versatile than a GPU, and with higher efficiency than a CPU. For example, the MPC(s) 431 may include a multi-threaded processor that allows multiple threads to share resources and execute instructions concurrently.

The SoC(s) 404 may include one or more programmable macro arrays (PMA(s)) 435. The PMA(s) 435 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 404 may include one or more display processing units (DPUs) 445 for performing hardware-accelerated image processing. For example, the DPU(s) 445 may retrieve pixel data from memory 415 and send it to a display peripheral through standard interfaces. As such, the DPU(s) 445 may handle display processing and rendering for in-machine and/or on-machine displays.

The SoC(s) 404 may include one or more application processing units (APUs) 439. For example, the APU(s) 439 may include a quad or dual-core processor with 48 KB/32 KB L1 cache with parity and ECC, along with a 1 MB L2 cache with ECC. The APU(s) 439 may support NEON instructions and single and double precision floating point operations.

The SoC(s) 404 may include one or more real-time processing units (RTPUs) 469. The RTPU(s) 469 may include a dual-core processor with 32 KB/32 KB L1 cache, and 256 KB TCM with ECC. The RTPU(s) 469 may support single and double precision floating point operations.

The SoC(s) 404 may include one or more built-in self-test (BIST) components 437. For example, the BIST component(s) 437 may include memory BIST (MBIST) to test memories of the system and/or logic BIST (LBIST) to test logic of the system. The BIST components 437 may include embedded logic for directly testing logic and/or memory of the system.

The SoC(s) 404 may include one or more dynamically reconfigurable processors (DRPs) 471. For example, the DRP(s) 471 may be used for accelerating various computing operations. For example, the DRP(s) 471 may be combined, in embodiments, with a MAC unit for use as an AI accelerator. In embodiments, the DRP(s) 471 may execute applications while dynamically switching the circuit connection configuration of the arithmetic units (e.g., ALUs) on the chip at each operating clock according to the content to be processed. Since only the necessary arithmetic circuits are used, the DRP(s) 471 may consume less power than with CPU processing and can achieve higher speed. Furthermore, compared to CPUs, where frequent external memory accesses due to cache misses and other causes will degrade performance, the DRP(s) 471 can build the necessary data paths in hardware ahead of time, resulting in less performance degradation and less variation in operating speed (jitter) due to memory accesses. The DRP(s) 471 may include a dynamic loading function that switches the circuit connection information each time the algorithm changes, enabling processing with limited hardware resources, even in robotic/automotive applications that require processing of multiple algorithms.

In some embodiments, the accelerator(s) 414 may include an OpenCV accelerator for speeding up processing of OpenCV, an open-source industry standard library for computer vision processing. In some embodiments, the combination of one or more DRP(s) 471 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 404 may include various compute engines (e.g., processors 410, CPUs 406, GPU(s) 408, accelerator(s) 414, etc.), tasks may be distributed between and among the compute engines, in some instances without common cause failures due to the discrete footprint of the compute engines. Further, because the SoC(s) 404 may include a dedicated safety processor(s) 413 (or safety island 413), critical safety or redundant operations may be performed without common cause failures from the main processing components or compute engines of the SoC(s) 414. Due to these features, the SoC(s) 404 and/or the underlying systems of the machine 400 may be capable of satisfying higher levels of safety—such as automotive safety integrity level (ASIL) D from the ISO 26262 standard.

FIG. 4E is a system diagram for communication between a cloud-based server(s) (e.g., in a data center, such as those described herein) and the example autonomous or semi-autonomous vehicle or machine 400 of FIG. 4A, in accordance with some embodiments of the present disclosure. The system 476 may include a server(s) 478, a network(s) 490, and a machine(s) 400. The server(s) 478 may include a plurality of GPUs 484(A)-484(H) (collectively referred to herein as GPUs 484), switches 482(A)-482(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 480(A)-480(B) (collectively referred to herein as CPUs 480), accelerators, and/or other processor types. The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the machine(s) 400, sensor data indicating information about new or previously unexplored locations, and/or sensor data indicating changes to previously seen/stored locations (e.g., unexpected or changed road conditions, such as recently commenced road-work). The server(s) 478 may transmit, over the network(s) 490 and to the machine(s) 400, neural networks 492, updated neural networks 492, map information 494, etc., including information regarding traffic and road conditions. The updates to the map information 494 may include updates for the HD map 422, SD map, navigation map, etc., such as information regarding construction sites, potholes, detours, flooding, and/or other obstructions. In some examples, the neural networks 492, the updated neural networks 492, the map information 494, and/or the other information may have resulted from new training and/or experiences represented in data received from any number of machine(s) 400 in the environment, and/or based on training performed at a datacenter (e.g., using the server(s) 478 and/or other servers).

The server(s) 478 may be used to train machine learning models (e.g., neural networks) based on training data. The training data may be generated by the machine(s) 400, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 400 (e.g., transmitted to the machine(s) 400 over the network(s) 490, and/or the machine learning models may be used by the server(s) 478 to remotely monitor and/or control the machine(s) 400.

In some examples, the server(s) 478 may receive data from the machine(s) 400 and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the machine 400. For example, the deep-learning infrastructure may receive periodic updates from the machine 400, such as a sequence of images and/or objects that the machine 400 has located in that sequence of images (e.g., via computer vision and/or other machine learning object classification techniques). The deep-learning infrastructure may run its own neural network to identify the objects and compare them with the objects identified by the machine 400 and, if the results do not match and the infrastructure concludes that the AI in the machine 400 is malfunctioning, the server(s) 478 may transmit a signal to the machine 400 instructing a fail-safe computer of the machine 400 to assume control, notify the passengers, and complete a safety maneuver or operation—such as to slow down, hand control back to a driver, come to a stop, and/or pull over/shut down.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 5 is a system diagram illustrating a three computer ecosystem 500, including a first computing system 502 for generating or creating artificial intelligence (AI)—such as AI training and validation data, a second computing system 504 for training artificial intelligence, and a third computing system 506 (which may include or correspond to the SoC(s) 404 of FIGS. 4A-4E) deploying the AI at the edge, in accordance with at least some embodiments of the present disclosure. For example, to develop and deploy embodied or physical AI, the three computer ecosystem 500 may be used, including three accelerated computer systems to handle physical AI training, simulation, and runtime (e.g., edge deployment). These systems may generate training data for and train multimodal foundation models (and/or other model types) using scalable, physically based simulations of the machine(s) 400 and their worlds. By doing so, simulation of machine(s) 400 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 400 can perform safely in controlled settings.

The computing system 504 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 400 to understand natural language and emulate movements by observing human actions. The computing system 504 may include a platform that incorporates software, infrastructure, and expertise in a modern, unified AI development and training solution. The computing system 504 may include individual computing devices 510 (e.g., NVIDIA's DGX B200, H200, etc.) and/or any number of computing devices 510 in a data center infrastructure 512 (e.g., NVIDIA's DGX SuperPOD).

For example, the individual computing devices 510 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 510 may include memory (e.g., 4 TB memory, and storage (e.g., OS storage of 2×1.9 TB NVMe M.2, and internal storage of 8×3.84 TB NVMe U.2). The computing devices 510 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 510 may further include, e.g., dual port quad small form-factor pluggable (QSFFP) data processing units (DPUs) (e.g., 2 dual-port QSFP 112 DPUs—such as NVIDIA's BlueField-3 DPUs), providing up to 400 Gb/s InfiniBand/Ethernet. The computing device(s) 510 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 510 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 510 may include a smart host channel adapter (HCA) (e.g., NVIDIA's ConnectX-7) to provide ultra-low latency, 400 Gb/s throughput for in-network computing acceleration engines.

The data center infrastructure 512 may include any number of the computing devices 510, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 510) to thousands, job scheduling and orchestration to ensure hassle-free execution of every developer's job, AI workflow management and machine learning operations (MLOps) to move more models from prototype to production, and enterprise software to speed developer success.

The computing system 502 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 502 allows developers to use simulation frameworks to simulate and validate robot models, and/or to generate massive amounts of physically-based synthetic data to bootstrap model training. The computing system 502 may support learning frameworks that power robot reinforcement learning and imitation learning, to accelerate robot policy training and refinement. For example, the computing system 502 may be used to generate any number of simulations 508—such as within NVIDIA's OMNIVERSE. The computing system 502 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 502 may host or support a native OpenUSD software platform enabling enterprises to connect 3D pipelines and develop advanced, real-time 3D applications for industrial digitalization. With powerful ray-tracing-accelerated AI and graphics capabilities, the computing system 502 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 502 may include individual computing devices 514 (e.g., NVIDIA's OVX L40S Server) and/or any number of computing devices 514 in a data center infrastructure 516 (e.g., NVIDIA's OVX Systems).

The computing device(s) 514 (which may include a server) may include CPUs (e.g., 2 CPUs with 32 cores each), and GPUs (e.g., 4 or 8 GPUs, each including 48 GB GDDR 6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 514 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP 112 DPUs—such as an NVIDIA BlueField-3 DPU), providing up to 400 Gb/s InfiniBand/Ethernet. In some embodiments, the NICs used for the computing device(s) 514 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 514 may include a smart host channel adapter (HCA) (e.g., NVIDIA's ConnectX-7) to provide ultra-low latency, 400 Gb/s throughput for in-network computing acceleration engines. The computing device(s) 514 may include a host memory (e.g., 384 Gb DDR 5 ECC for 4 GPUs, or 768 Gb DDR 5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 512, the data center infrastructure 516 may allow for any number of computing device(s) 514 to be combined in cluster configuration according to a reference architecture.

The computing system 506 may be used to deploy trained AI models on a runtime computer—such as the SoC(s) 404 described herein. For example, these computing systems 506 may be designed for compact, on-board computing needs, including an ensemble of models for control policy, vision and language models, etc., deployed on a power-efficient on-board edge computing system 506. Details of components, features, and capabilities of the computing system 506 may be described in more detail herein with respect to FIGS. 4A-4E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 6 is a block diagram of an example generative language model system 600 suitable for use in implementing at least some embodiments of the present disclosure. In the example illustrated in FIG. 6, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a MMLM, a VLA model, etc.).

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 630 (e.g., LLM/VLM/MMLM/etc.). In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multi-modal inputs, the input 601 may combine text (or may omit text) with image data, audio data, video data, design data, USD data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 605 may remove stopwords to reduce noise and focus the generative LM 630 on more meaningful content. The input processor 605 may apply text normalization (TN), for example, by converting all characters to lowercase, removing accents, and/or or handling special cases like contractions or abbreviations to ensure consistency (e.g., converting ¼ to one quarter). Similarly, the input processor 605 and/or a post-processor may perform inverse text normalization (ITN) in order to convert plain language back to canonical or other forms (e.g., to convert one quarter to ¼) . These are just a few examples, and other types of input and/or output processing may be applied.

In some embodiments, a RAG component 692 (which may include one or more RAG models, and/or may be performed using the generative LM 630 itself) may be used to retrieve additional information to be used as part of the input 601 or prompt. RAG may be used to enhance the input to the LLM/VLM/MMLM/etc. with external knowledge, so that answers to specific questions or queries or requests are more relevant—such as in a case where specific knowledge is required. The RAG component 692 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history—or at least a summary thereof—and include the prior conversation history along with the current ask/request as part of the input 601 to the generative LM 630.

The RAG component 692 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 692 and the embeddings of the chunks along with the embeddings of the query may be compared to identify the most similar/related embeddings to the query, which may be supplied to the generative LM 630 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 692 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 610 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data/video data/etc., the input processor 601 may resize the data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features—such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multi-modal data, the embedding component 620 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 630 and/or other components of the generative LM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use—or capable of accessing or using—plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated—e.g., recursively-for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources—such as the plug-ins/APIs 695.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs-to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s), speaker(s), etc.), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Clause 1. One or more processors comprising processing circuitry to generate a candidate trajectory associated with an ego-machine.

Clause 2. The one or more processors of clause 1, wherein the processing circuitry is further to compute, based at least on processing a representation of the candidate trajectory using one or more neural networks, an estimated favorability of a future world state corresponding to the candidate trajectory.

Clause 3. The one or more processors of clause 1 or 2, wherein the processing circuitry is further to determine whether to use the candidate trajectory to control navigation of the ego-machine based at least on the estimated favorability of the future world state.

Clause 4. The one or more processors of clause 1, 2 or 3, wherein the processing circuitry is further to generate a predicted distribution of future world states corresponding to the candidate trajectory based at least on processing the representation of the candidate trajectory using a world model neural network of the one or more neural networks, and to sample the future world state from the predicted distribution.

Clause 5. The one or more processors of clause 1, 2 or 3, wherein the processing circuitry is further to determine, based at least on the estimated favorability of the future world state not satisfying a designated threshold, at least one of: not to engage autonomous navigation, to disengage autonomous navigation, to disable one or more autonomous or semi-autonomous features of the ego-machine, or to execute a safety procedure associated with the ego-machine.

Clause 6. The one or more processors of clause 1, 2 or 3, wherein the processing circuitry is further to use, based at least on the estimated favorability of the future world state not satisfying a designated threshold, an optimization process to generate an alternate trajectory that optimizes a corresponding estimated favorability of an alternate future world state corresponding to the alternate trajectory.

Clause 7. The one or more processors of clause 1, 2 or 3, wherein the processing circuitry is further to execute one or more iterations of an optimization process that predicts an alternate candidate trajectory and uses the one or more neural networks to generate a corresponding estimated favorability of an alternate future world state corresponding to the alternate candidate trajectory.

Clause 8. The one or more processors of clause 1, 2 or 3, wherein the processing circuitry is further to decrease a velocity of the ego-machine in response to determining to use an optimization process to generate an alternate trajectory that optimizes a corresponding estimated favorability of an alternate future world state corresponding to the alternate trajectory.

Clause 9. The one or more processors of clause 1, 2 or 3, wherein the processing circuitry is further to include, in a training dataset, a representation of sensor data and a corresponding alternate trajectory that is generated based at least on optimizing a corresponding estimated favorability of an alternate future world state corresponding to the alternate trajectory.

Clause 10. The one or more processors of clause 1, 2 or 3, wherein the processing circuitry is further to execute one or more iterations of training a neural planner based at least on an alternate trajectory generated based at least on optimizing a corresponding estimated favorability of an alternate future world state corresponding to the alternate trajectory.

Clause 11. The one or more processors of clause 1, 2 or 3, wherein the one or more processors in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Clause 12. A method comprising generating, based at least on one or more neural networks evaluating a candidate trajectory generated using a processing pipeline associated with an ego-machine, an estimated quality, safety, or desirability of a future scene state generated based at least on the candidate trajectory.

Clause 13. The method of clause 12, further comprising determining whether to use the candidate trajectory to control navigation of the ego-machine based at least on the estimated quality, safety, or desirability of the future scene state.

Clause 14. The method of clause 12 or 13, further comprising generating a predicted distribution of future scene states corresponding to the candidate trajectory based at least on processing a representation of the candidate trajectory using a world model neural network of the one or more neural networks, and sampling the estimated future scene state from the predicted distribution.

Clause 15. The method of clause 12 or 13, further comprising determining, based at least on the estimated quality, safety, or desirability of the future scene state not satisfying a designated threshold, at least one of: not to engage autonomous navigation, to disengage autonomous navigation, to disable one or more autonomous or semi-autonomous features of the ego-machine, or to execute a safety procedure associated with the ego-machine.

Clause 16. The method of clause 12 or 13, further comprising determining, based at least on the measure of estimated quality of the estimated future scene state not satisfying a designated threshold, to use an optimization process to generate an alternate trajectory that optimizes a corresponding measure of estimated quality of an alternate estimated future scene state corresponding to the candidate trajectory.

Clause 17. The method of clause 12 or 13, further comprising executing one or more iterations of an optimization process that predicts an alternate candidate trajectory and uses the one or more neural networks to generate a corresponding estimated quality, safety, or desirability of an alternate future scene state corresponding to the alternate candidate trajectory.

Clause 18. The method of clause 12 or 13, wherein the method is performed by at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Clause 19. An autonomous or semi-autonomous machine comprising one or more systems-on-a-chip (SoCs) individually comprising one or more central processing units (CPUs), one or more graphics processing units (GPUs), and one or more hardware accelerators.

Clause 20. The autonomous or semi-autonomous machine of clause 19, comprising one or more sensors having fields of view or sensory fields external to the autonomous or semi-autonomous machine, wherein the autonomous or semi-autonomous machine navigates according to a selected trajectory, the trajectory being selected from at least one candidate trajectory, generated based at least on an end-to-end neural network processing sensor data obtained using the one or more sensors, based at least on the at least one candidate trajectory satisfying a quality, desirability, or safety threshold associated with a future world state, the future world state generated using the at least one candidate trajectory.

Clause 21. The autonomous or semi-autonomous machine of clause 19 or 20, wherein a single SoC of the one or more SoCs is capable of 275 tera operations per second (TOPS) of AI performance.

Clause 22. The autonomous or semi-autonomous machine of clause 19 or 20, wherein the one or more hardware accelerators include at least one of a vision accelerator, a ray-tracing accelerator, an optical flow accelerator, or a deep learning accelerator.

Clause 23. The autonomous or semi-autonomous machine of clause 19 or 20, wherein the autonomous or semi-autonomous machine includes a vehicle, a car, a truck, a robot, a humanoid robot, an autonomous mobile robot (AMR), a warehouse vehicle, a drone, a watercraft, or an aircraft.

Clause 24. The autonomous or semi-autonomous machine of clause 19 or 20, wherein the autonomous or semi-autonomous machine includes or uses at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a candidate trajectory associated with an ego-machine;
compute, based at least on processing a representation of the candidate trajectory using one or more neural networks, an estimated favorability of a future world state corresponding to the candidate trajectory; and
determine whether to use the candidate trajectory to control navigation of the ego-machine based at least on the estimated favorability of the future world state.

2. The one or more processors of claim 1, wherein the processing circuitry is further to generate a predicted distribution of future world states corresponding to the candidate trajectory based at least on processing the representation of the candidate trajectory using a world model neural network of the one or more neural networks, and to sample the future world state from the predicted distribution.

3. The one or more processors of claim 1, wherein the processing circuitry is further to determine, based at least on the estimated favorability of the future world state not satisfying a designated threshold, at least one of: not to engage autonomous navigation, to disengage autonomous navigation, to disable one or more autonomous or semi-autonomous features of the ego-machine, or to execute a safety procedure associated with the ego-machine.

4. The one or more processors of claim 1, wherein the processing circuitry is further to use, based at least on the estimated favorability of the future world state not satisfying a designated threshold, an optimization process to generate an alternate trajectory that optimizes a corresponding estimated favorability of an alternate future world state corresponding to the alternate trajectory.

5. The one or more processors of claim 1, wherein the processing circuitry is further to execute one or more iterations of an optimization process that predicts an alternate candidate trajectory and uses the one or more neural networks to generate a corresponding estimated favorability of an alternate future world state corresponding to the alternate candidate trajectory.

6. The one or more processors of claim 1, wherein the processing circuitry is further to decrease a velocity of the ego-machine in response to determining to use an optimization process to generate an alternate trajectory that optimizes a corresponding estimated favorability of an alternate future world state corresponding to the alternate trajectory.

7. The one or more processors of claim 1, wherein the processing circuitry is further to include, in a training dataset, a representation of sensor data and a corresponding alternate trajectory that is generated based at least on optimizing a corresponding estimated favorability of an alternate future world state corresponding to the alternate trajectory.

8. The one or more processors of claim 1, wherein the processing circuitry is further to execute one or more iterations of training a neural planner based at least on an alternate trajectory generated based at least on optimizing a corresponding estimated favorability of an alternate future world state corresponding to the alternate trajectory.

9. The one or more processors of claim 1, wherein the one or more processors in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

10. A method comprising:
generating, based at least on one or more neural networks evaluating a candidate trajectory generated using a processing pipeline associated with an ego-machine, an estimated quality, safety, or desirability of a future scene state generated based at least on the candidate trajectory; and
determining whether to use the candidate trajectory to control navigation of the ego-machine based at least on the estimated quality, safety, or desirability of the future scene state.

11. The method of claim 10, further comprising generating a predicted distribution of future scene states corresponding to the candidate trajectory based at least on processing a representation of the candidate trajectory using a world model neural network of the one or more neural networks, and sampling the estimated future scene state from the predicted distribution.

12. The method of claim 10, further comprising determining, based at least on the estimated quality, safety, or desirability of the future scene state not satisfying a designated threshold, at least one of: not to engage autonomous navigation, to disengage autonomous navigation, to disable one or more autonomous or semi-autonomous features of the ego-machine, or to execute a safety procedure associated with the ego-machine.

13. The method of claim 10, further comprising determining, based at least on the measure of estimated quality of the estimated future scene state not satisfying a designated threshold, to use an optimization process to generate an alternate trajectory that optimizes a corresponding measure of estimated quality of an alternate estimated future scene state corresponding to the candidate trajectory.

14. The method of claim 10, further comprising executing one or more iterations of an optimization process that predicts an alternate candidate trajectory and uses the one or more neural networks to generate a corresponding estimated quality, safety, or desirability of an alternate future scene state corresponding to the alternate candidate trajectory.

15. The method of claim 10, wherein the method is performed by at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

16. An autonomous or semi-autonomous machine comprising:
one or more systems-on-a-chip (SoCs) individually comprising one or more central processing units (CPUs), one or more graphics processing units (GPUs), and one or more hardware accelerators; and
one or more sensors having fields of view or sensory fields external to the autonomous or semi-autonomous machine,
wherein the autonomous or semi-autonomous machine navigates according to a selected trajectory, the trajectory being selected from at least one candidate trajectory, generated based at least on an end-to-end neural network processing sensor data obtained using the one or more sensors, based at least on the at least one candidate trajectory satisfying a quality, desirability, or safety threshold associated with a future world state, the future world state generated using the at least one candidate trajectory.

17. The autonomous or semi-autonomous machine of claim 16, wherein a single SoC of the one or more SoCs is capable of 275 tera operations per second (TOPS) of AI performance.

18. The autonomous or semi-autonomous machine of claim 16, wherein the one or more hardware accelerators include at least one of a vision accelerator, a ray-tracing accelerator, an optical flow accelerator, or a deep learning accelerator.

19. The autonomous or semi-autonomous machine of claim 16, wherein the autonomous or semi-autonomous machine includes a vehicle, a car, a truck, a robot, a humanoid robot, an autonomous mobile robot (AMR), a warehouse vehicle, a drone, a watercraft, or an aircraft.

20. The autonomous or semi-autonomous machine of claim 16, wherein the autonomous or semi-autonomous machine includes or uses at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
